(19) United States
(12) Patent Application Publication
(10) Pub. No.: US 2017/0240435 A1
(43) Pub. Date: Aug. 24, 2017

(54) POLYMERIC HYBRID PARTICLE CONTAINING NANO PARTICLES AND USES

(71) Applicant: HALOSOURCE, INC., Bothell, WA (US)

(72) Inventors: Yongjun Chen, Bothell, WA (US); Hiroyuki Kawai, Edmonds, WA (US)

(73) Assignee: HALOSOURCE, INC., Bothell, WA (US)

(21) Appl. No.: 15/519,132

(22) PCT Filed: Oct. 14, 2015
(86) PCT No.: PCT/US2015/055584

§ 371 Date: Apr. 13, 2017

Related U.S. Application Data
(60) Provisional application No. 62/063,862, filed on Oct. 14, 2014.
(60) Provisional application No. 62/066,759, filed on Oct. 21, 2014.
(60) Provisional application No. 62/067,876, filed on Oct. 23, 2014.
(60) Provisional application No. 62/120,209, filed on Feb. 24, 2015.

(51) Int. Cl. C02F 1/28; A01N 25/10; A01N 59/00; C08F 8/20; C02F 1/50; B01J 20/26; B01J 20/34; C08F 112/14; A01N 59/16

(52) U.S. Cl. CPC C02F 1/288; C08F 112/14; A01N 25/10; A01N 59/00; A01N 59/16; C02F 1/281; C02F 1/285; C02F 1/50; B01J 20/261; B01J 20/267; B01J 20/3425; B01J 20/3475; C08F 8/20; C02F 2101/103

(57) ABSTRACT

A polymeric hybrid particle or composition comprising of polymers, such as polystyrene or methylated polystyrenes with cyclic amines and their halogenated forms, and nanoparticles (NPs). The method for the preparation thereof and uses as nano-adsorbent, or a biocide, or a dual function combination of biocide and adsorbent for use in a fluid system for the purpose of purification or remediation are also disclosed.

### CROSS-REFERENCE(S) TO RELATED APPLICATION(S)

This application claims the benefit of U.S. Provisional Application No. 62/063,862, filed on Oct. 14, 2014; 62/066,759, filed on Oct. 21, 2014; 62/067,876, filed on Oct. 23, 2014; and 62/120,209, filed on Feb. 24, 2015, all being herein expressly incorporated by reference for all purposes.

### FIELD OF THE INVENTION

Embodiments of the present invention relate to a polymer hybrid particle or composition comprising of polymers, such as polystyrenehydantoin or methylated polystyrene or their halogenated forms and other cyclic amine and N-halamine polymers, and nanoparticles (NPs); and uses as a nano-adsorbent, or a biocide, or a combination of biocide and adsorbent for fluid systems such as water for the purpose of purification or remediation.

### BACKGROUND

Safe and clean drinking-water is a basic need for human development, health and well-being. As the water quality is deteriorating continuously due to industrialization, civilization, domestic and agricultural activities, geometrical growth of population, and other geological and environmental changes, thousands of organic, inorganic, and biological pollutants have been reported as water contaminants. The concern associated with water contamination is becoming more and more serious and is in urgent need of being addressed. The increasing consumption of contaminated water for humans is also raising more and more health-related public concerns. Therefore, the technology needed for improving the remediation of waste or polluted water produced by industrial, agricultural, or domestic activities to minimize water contamination or pollution continues to grow dramatically in the U. S. and abroad. Another urgent need is also growing dramatically for drinking water purification technology to remove contaminates from drinking water sources to provide safer and cleaner potable water.

Generally, the contaminants in the water can be categorized into chemical contaminants and biological contaminants. As water deteriorates through pollution, the potential health and safety issues associated with the chemical contaminants in the water becomes a significant concern. Some examples of chemical contaminants include inorganic anions (fluoride, arsenic, nitrate, chromate, selenate, selenite, etc.); metals; heavy metals (lead, mercury, cadmium, zinc, copper, chromium, etc.); synthetic or natural organic matters (humic acid, tannic acid, tannins, fulvic acid); residual halogen (residual chlorine, residual chloramine, or residual bromine). It is well known that most of the heavy metals are toxic to human beings and should be removed from drinking water, and the residual halogen is also associated with the taste and odor of the drinking water.

Some contaminants are notorious water pollutants with high toxicity and carcinogenicity, such as lead, mercury, arsenic, cadmium, chromium, selenium, and some water anions also demonstrate hazardous effects or water taste changes, such as fluoride, nitrate, phosphate, sulfate, chloride, and oxalate.

For a few decades, different methods have been developed and used for water purification and or remediation to reduce the above-said chemical contaminants. Adsorption is considered as one of the suitable water treatment methods due to its ease of operation, high effectiveness of removal of soluble and insoluble organic, inorganic, and biological pollutants, and the availability of a wide range of adsorbents.

U.S. Pat. No. 7,291,578, issued to SenGupta, et al., discloses that polymeric anion exchangers are used as host materials in which hydrated Fe(III) Oxides (HFO) are irreversibly dispersed within the exchanger beads. Since the anion exchangers have positively charged quaternary ammonium functional groups, anionic ligands such as arsenates, chromates, oxalates, phosphates, phthalates can permeate in and out of the gel phase and are not subjected to the Donnan exclusion effect. Consequently, anion exchanger-supported HFO micro particles exhibit significantly greater capacity to remove arsenic and other ligands in comparison with cation exchanger supports. Loading of HFO particles is carried out by preliminary loading of the anion exchange resin with an oxidizing anion such as MnO₄⁻ or OCl⁻, followed by passage of a Ferrous Sulfate solution through the resin.

U.S. Pat. No. 7,504,036, issued to Gottlieb, et al., discloses the impregnating metal complexes into anion exchange materials to provide improved anion exchange materials with a metal inside the materials such that the modified materials can effectively and efficiently remove or recover various metals, including metal containing complexes, compounds, and contaminants, such as arsenic, from, for example, process solutions, effluents and aqueous solutions. Uses for the improved anion exchange materials are also described as are methods of making modified anion exchange materials, and methods of removing and recovering at least one metal or contaminant from a source.

U.S. Pat. No. 7,708,892, issued to Klipper, et al., discloses the use of inorganic salts for increasing the adsorption of oxoanions and/or thioanalogues thereof to metal-doped ion exchangers, preferably to iron oxide/iron oxyhydroxide-containing ion exchangers, preferably from water or aqueous solutions, and also the conditioning of these metal-doped ion exchangers having increased adsorption behavior toward oxoanions and/or thioanalogues thereof by using inorganic salts with the exception of amphoteric ion exchangers, which have both acidic and basic groups as functional groups.

U.S. patent application Ser. No. 11/854,959 discloses a method of forming nanocomposites within a polymer structure includes exposing a wettable polymer having ion-exchangeable groups pendant therefrom to an aqueous solution of a soluble salt containing metal ions, the metal ions replacing, by ion exchange, the pendant groups on the polymer. After ion exchange, the polymer is repetitively exposed to an oxidizing and/or reducing agent to form metal oxides, metal particles, metallic alloys, or combinations and mixtures thereof, trapped within the polymer structure.

WO2004/110623 discloses a method for producing an ion exchanger carrying carboxyl groups and containing iron oxide/iron oxyhydroxide, said method being characterized in that a) a bead-type ion exchanger containing carboxyl groups in an aqueous suspension is brought into contact with iron-(III)-salts, or an aminomethylated, cross-linked polystyrol bead polymer in an aqueous suspension is brought into contact with iron-(III)-salts and chloroacetic acid, and b) the pH values of the suspensions obtained in steps a) or are adjusted to between 3 and 14 by adding alkali hydroxides or alkaline-earth hydroxides, and the obtained ion exchangers containing iron oxide/iron oxyhydroxide are isolated according to known methods. Embodiments of the invention also relate to such ion exchangers, and to the use thereof for the adsorption of heavy metals, especially arsenic.

U.S. Pat. No. 6,548,054, issued to Worley et al., incorporated herein by reference in its entirety, discloses a biocidal halogenated polystyrene hydantoin particles. The cross-linked and porous halogenated polystyrene hydantoin beads, also referred to HaloPure™, have been commercialized by HaloSource, Inc., as a contact biocide, can be broadly applied to water disinfection, such as point of use or point of entry.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Embodiments of the present invention relate to a polymeric hybrid particle or composition comprising of polymers, such as polystyrenehydantoin or methylated polystyrene or their halogenated forms or other cyclic amine and N-halamine polymers, and nanoparticles (NPs). The method for the preparation thereof and uses as nano-adsorbent, or a biocide, or a combination of dual functions of biocide and adsorbent in the fluid system for the purpose of purification or remediation are also disclosed. Specifically, embodiments of the present invention provide the composition and use thereof for water purification or remediation as a nano-adsorbent, or a biocide, or a combination of biocidal and chemical contaminants reduction.

In some embodiments, a composition comprises a polystyrene polymer comprising one or more precursor N-halamine groups or one or more N-halamine groups, wherein each group is linked to a phenyl or a benzyl group of the polystyrene polymer; and one or more nanoparticles linked to the polystyrene polymer.

In some embodiments, the precursor N-halamine group or N-halamine group is an imidazolidinone group, an oxazolidinone group, an isocyanurate group, a hydantoin group, or a 3-hydroxyalkylhydantoin group.

In some embodiments, the polystyrene polymer comprises both precursor N-halamine groups and N-halamine groups, wherein precursor N-halamine groups comprise a majority.

In some embodiments, the polystyrene polymer comprises both precursor N-halamine groups and N-halamine groups, wherein N-halamine groups comprise a majority.

In some embodiments, the polystyrene polymer is crosslinked.

In some embodiments, the polystyrene polymer comprises pores.

In some embodiments, the nanoparticles are selected from iron oxides, iron oxyhydroxides, hydrated ferric oxides, titanium oxides, alumina, zirconium oxide, cerium oxide, manganese oxides, zinc oxides, magnetic iron oxides or any combination of thereof.

In some embodiments, the composition has a polystyrene comprising units represented by the following formula.

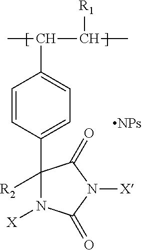

wherein,

R₁ is a hydrogen or methyl group;

R₂ is a C₁-C₈ alkyl or phenyl group;

X and X′ are independently chlorine, bromine, or hydrogen; and

NPs are nanoparticles.

In some embodiments, at least one of X and X′ is chlorine or bromine.

In some embodiments, X and X′ are hydrogen.

In some embodiments, the composition has a polystyrene polymer comprising units of the following formula.

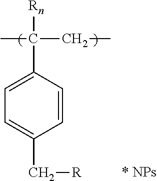

wherein R is selected from one or more of the following:

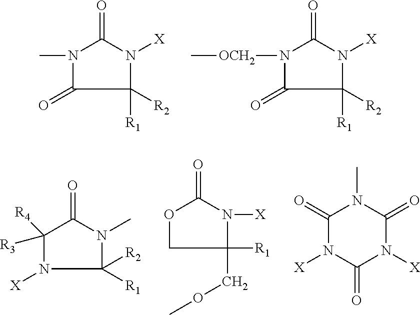

wherein,

Rₙ is a hydrogen or methyl group;

R₁ and R₂ are a C₁-C₈ alkyl or phenyl group;

X is chlorine, bromine, or hydrogen; and

NPs are nanoparticles.

In some embodiments, a method of reducing contaminants from a fluid comprises bringing a fluid containing contaminants into contact with a composition and producing decontaminated fluid.

In some embodiments, the contaminant comprises a halogen, chlorine, chloramine, bromine, selenium, selenite, selenate, arsenic, arsenite, arsenate, fluoride, phosphate, chromium, chromate, dichromate, a cation selected from Co²⁺, Zn²⁺, Pb²⁺, Cd²⁺, Cu²⁺, Cs⁺, Cr³⁺, Hg²⁺, Ni²⁺, or a natural organic matter (NOM), tannin, fulvic acid, humic acid.

In some embodiments, the method may further comprise inactivating microorganisms with the composition while reducing the contaminants.

In some embodiments, the microorganisms include viruses or bacteria or fungi.

In some embodiments, the method may further comprise bringing the fluid containing contaminants into contact with an iodinated resin or cross-linked and porous halogenated polystyrene hydantoin beads.

In some embodiments, a for regenerating a composition comprises obtaining a composition of any one of claims 1-10, wherein the composition has been in contact with a contaminated fluid; and bringing the composition into contact with an alkaline aqueous liquid.

In some embodiments, the method for regeneration may further comprise collecting the alkaline aqueous liquid having contaminants.

In some embodiments, the method for regeneration may further comprise, after bringing the composition into contact with the alkaline aqueous liquid, rinsing the composition with a rinsing liquid, and then collecting the rinsing liquid having contaminants.

In some embodiments, the method for regeneration may further comprise, after rinsing the composition with the rinsing liquid, bringing the composition into contact with a pH conditioning liquid having a pH in the range of 4 to 9.

In some embodiments, the method for regeneration may further comprise, after rinsing the composition with the rinsing liquid, bringing the composition into contact with a rechlorination or rebromination liquid.

In some embodiments, a composition comprises a polymer comprising one or more precursor N-halamine groups or one or more N-halamine groups, wherein each group is linked to the polymer; and one or more nanoparticles linked to the polymer. In some embodiments, the polymer is crosslinked.

One embodiment provided is a polymeric hybrid particle or composition comprising of polystyrenehydantoin and nanoparticles (NPs), having the following chemical formulas, described as the following structure 1.

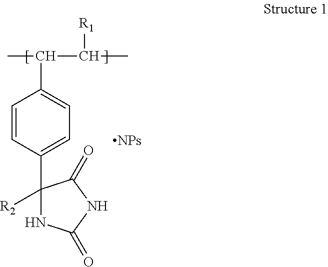

Wherein, the polystyrenehydantoin particles are made from crosslinked polystyrene particles. The polystyrenehydantoin particles are further described in U.S. Pat. No. 6,548,054, incorporated herein by reference in its entirety. The amount of crosslinking from initial crosslinked polystyrene particles is not less than 3%, and R₁ is H or methyl (CH₃); R₂ is C₁-C₈ alkyl or phenyl groups. NPs refers to nanoparticles chosen from nano iron oxides, nano iron oxyhydroxides, nano hydrated ferric oxides (HFO), nano titanium oxides, nanoalumina, nano zirconium oxide, nano cerium oxide, nano manganese oxides, nano zinc oxides, nano magnetic iron oxides or any combination of thereof.

One embodiment provided is a polymeric hybrid particle or composition comprising of halogenated polystyrenehydantoin, and nanoparticles (NPs), having the following chemical formulas, described as the following structure 2.

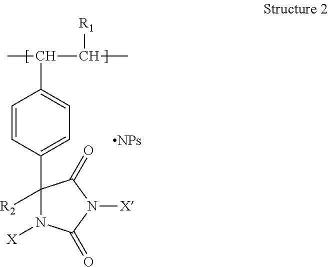

Wherein in structure 2, the halogenated polystyrenehydantoin particles are made from crosslinked polystyrene particles. The polystyrenehydantoin and halogenated polystyrenehydantoin particles are further described in U.S. Pat. No. 6,548,054, incorporated herein by reference in its entirety. The amount of crosslinking from initial crosslinked polystyrene particles is not less than 3%, and R₁ is H or methyl (CH₃); R₂ is C₁-C₈ alkyl or phenyl groups, X and X′ are independently chlorine (Cl), bromine (Br), or hydrogen (H), provided that at least one of X and X′ is Cl or Br. NPs refers to nanoparticles choosing from nano iron oxides, nano iron oxyhydroxides, nano hydrated ferric oxides (HFO), nano titanium oxides, nanoalumina, nano zirconium oxide, nano cerium oxide, nano manganese oxides, nano zinc oxides, or any combination of thereof.

In some embodiments, a polymeric hybrid particle or composition comprises a methylated polystyrene and nanoparticles (NPs) according to the following structures.

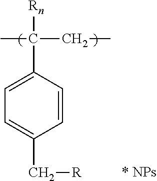

wherein R is selected from one or more of the following:

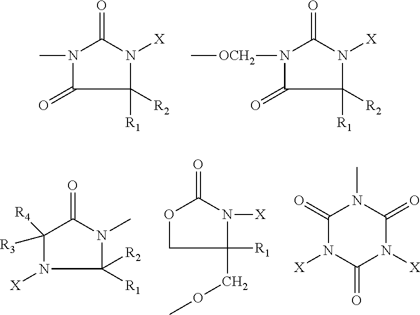

wherein,

Rₙ is a hydrogen or a C₁-C₈ alkyl or phenyl group;

R₁, R₂, R₃ and R₄ are a C₁-C₈ alkyl or phenyl group;

X is chlorine, bromine, or hydrogen; and

NPs are nanoparticles. NPs can be chosen from nano iron oxides, nano iron oxyhydroxides, nano hydrated ferric oxides (HFO), nano titanium oxides, nanoalumina, nano zirconium oxide, nano cerium oxide, nano manganese oxides, nano zinc oxides, nano magnetic iron oxides or any combination of thereof. In some embodiments, the nanoparticles function as adsorbents for a plurality of chemical compounds.

Further, in other embodiments, R₁, R₂, R₃, and R₄ are independently selected from C₁-C₄ alkyl, phenyl, or aryl; X is hydrogen, chlorine, or bromine, at least one of which must be chlorine or bromine when the compound is a biocidal N-halamine, X is not chlorine or bromine for precursor N-halamines. “Independently selected” encompasses all the combinations of the one or more R₁, R₂, R₃, and R₄ groups possible with the moieties selected from C₁-C₄ alkyl, phenyl and aryl. Thus, the R₁, R₂, R₃, and R₄ groups can all be the same group or can all be different groups or any other combination. The repeating unit appears consecutively if the polymeric compound is a homopolymer, or alternatively with one or more different repeating units if the polymeric compound is a copolymer. In some embodiments, the methylated polystyrene is crosslinked. The degree of crosslinking of the starting chloromethylated polystyrene can be in the range of from about 3 to about 10 weight percent for hardness and lack of solubility. In one embodiment, the degree of crosslinking is from about 5 to about 8 weight percent. There are many types of highly crosslinked, porous chloromethylated polystyrene beads that can be used in to make methylated polystyrene according to the above structure. The above being one example. The crosslinked methylated polystyrene has pore sizes in the range of from about 10 to about 100 nm, more preferably, in the range of from about 30 to about 70 nm. The methylated polystyrenes are described in U.S. Pat. No. 7,687,072, which is fully incorporated herein by reference.

In some embodiments, the polymers, such as polystyrenehydantoin or methylated polystyrene or their halogenated forms or other cyclic amine and N-halamine polymers can be provided as a particle, wherein the particle shape is in the form of a bead. However, other embodiments can provide highly crosslinked hydantoin in any other shape. In one embodiment, the bead is greater than 100 micron or from about 100 micron to about 1200 micron.

In some embodiments, polymers, such as polystyrenehydantoin or methylated polystyrene or their halogenated forms or other cyclic amine and N-halamine polymers, are particles having pores, wherein the average of the pore size is greater than about 1 nm or from about 1 nm to 100 nm.

In some embodiments, the halogenated polystyrenehydantoin particles have highly crosslinked N-halamine polymers of poly-1,3-dihalo-5-methyl-5-(4′-vinylphenyl)hydantoin, poly-1-halo-5-methyl-5-(4′-vinylphenyl)hydantoin, and the alkali salt derivative of the monohalo species, and mixtures thereof, wherein the halogen can be either chlorine or bromine.

In some embodiments, a polymeric hybrid particle or composition comprising of polymers, such as polystyrenehydantoin or methylated polystyrene or their halogenated forms or other cyclic amine and N-halamine polymers, and nanoparticles in accordance with the present invention can be used in ways to provide numerous advantages. A contaminated fluid media can be treated for reduction of chemical contaminants including without being limited to, residual halogen (residual chlorine, residual chloramine, residual bromine, et al), selenium (such as selenite, selenate, et al), arsenic (such as arsenite, arsenate), fluoride, phosphate, chromium (chromate or dichromate), toxic cations (Co²⁺, Zn²⁺, Pb²⁺, Cd²⁺, Cu²⁺, Cs⁺, Cr³⁺, Hg²⁺, Ni²⁺ et al), and natural organic matters NOMs (such as tannins, fulvic acid or humic acid).

In some embodiments, a polymeric hybrid particle or composition comprising of polymers, such as polystyrenehydantoin or methylated polystyrene or their halogenated forms or other cyclic amine and N-halamine polymers, and nanoparticles made in accordance with the present invention can also be formulated or blended with other disinfection components, such as iodine resin, HaloPure™ resin beads to provide a disinfection utility as well as a chemical reduction utility. The chemical contaminants include but are not limited to residual halogen (residual chlorine, residual chloramine, residual bromine, et al), selenium (such as selenite, selenate, et al), arsenic (such as arsenite, arsenate), fluoride, phosphate, chromium (chromate or dichromate), toxic cations (Co²⁺, Zn²⁺, Pb²⁺, Cd²⁺, Cu²⁺, Cs⁺, Cr³⁺, Hg²⁺, Ni²⁺, et al), and natural organic matters NOMs (such as tannins, fulvic acid or humic acid).

In some embodiments, a polymeric hybrid particle or composition comprising of polymers, such as polystyrenehydantoin or methylated polystyrene or their halogenated forms or other cyclic amine and N-halamine polymers, and nanoparticles made in accordance with the present invention can be used in ways to provide numerous advantages. A contaminated fluid media can be treated for microorganism disinfection and reduction of chemical contaminants including but without being limited to residual halogen (residual chlorine, residual chloramine, residual bromine, et al), selenium (such as selenite, selenate), arsenic (such as arsenite, arsenate), fluoride, phosphate, chromium (chromate or dichromate), toxic cations (Co²⁺, Zn²⁺, Pb²⁺, Cd²⁺, Cu²⁺, Cs⁺, Cr³⁺, Hg²⁺, Ni²⁺, et al), and natural organic matters NOMs (such as tannins, fulvic acid or humic acid).

In some embodiments, after a polymeric hybrid particle or composition comprising of polymers, such as polystyrenehydantoin or methylated polystyrene or other cyclic amine polymers, and nanoparticles, made in accordance with the present invention is exhausted by saturated exposure to chemical contaminants from the contaminated fluid, the hybrid particle or composition can be further regenerated for reuse.

In some embodiments, after a polymeric hybrid particle or composition comprising of polymers, such as halogenated polystyrenehydantoin or methylated polystyrene with N-halamines or other cyclic amine and N-halamine polymers, and nanoparticles made in accordance with the present invention is exhausted by saturated exposure to chemical contaminants or biological contaminants (such as bacteria, viruses) from the contaminated fluid, the hybrid particle or composition can be further regenerated for reuse.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a flow diagram of a method for using hybrid particles and a method of regenerating hybrid particles;

FIG. 2 is a flow diagram of a method for using hybrid particles and a method of regenerating hybrid particles;

FIG. 3 is a flow diagram of a method for making hybrid particles;

FIG. 4 is a flow diagram of a method for making hybrid particles;

FIG. 5 is a scanning electron micrograph (SEM) of crosslinked porous polystyrenehydantoin beads;

FIG. 6 is an SEM of hybrid chlorinated polystyrenehydantoin beads and hydrated ferric oxides (HFO) nanoparticles;

FIG. 7 is an SEM of polystyrenehydantoin beads;

FIG. 8 is an SEM of hybrid of polystyrenehydantoin beads and hydrated ferric oxide nanoparticles;

FIG. 9 is an EDS map sum spectrum of Dichlor HFO Hybrid;

FIG. 10A is a scan of an EDS layered image of chlorine;

FIG. 10B is a scan of an EDS layered image of iron;

FIG. 11 is an SEM of methylated polystyrene beads; and

FIG. 12 is an SEM of hybrid MPSH and HFO nanoparticles.

### DETAILED DESCRIPTION

The present invention may be understood more readily by reference to the following detailed description of embodiments and the Examples and Figures included therein.

Disclosed is a hybrid particle or composition having polymers linked to nanoparticles that can provide a dual function of water disinfection through biological and chemical contaminants reduction for water purification or remediation.

In order to significantly improve the performance of conventional adsorbents, the introduction of nano-technology into the industry represents a significant advancement. Compared with the conventional adsorbents, nanoparticles (NPs) are excellent adsorbents due to their unique features. The characteristics of the nanoparticles, which make them ideal adsorbents, are small size, catalytically potential, high reactivity, large surface area, ease of separation, and large number of active sites for interaction with different contaminants. Among those nanoparticles, nano metal oxides or nano metals, such as nano zero valent iron (nZVI), nano ironhydroxide, nano iron oxides, nano alumina, nano titanium oxide, etc., have been well-known for use in the water purification and remediation applications. Metal and metal oxide nanoparticles (NPs) exhibit unique properties in regard to sorption behaviors, magnetic activity, chemical reduction, ligand sequestration. To this end, attempts are being continuously made to take advantage of them in multitude of applications including separation, catalysis, environmental remediation, purification, and others. However, metal and metal oxide NPs lack chemical stability and mechanical strength. They exhibit extremely high pressure drop or head loss in a fixed-bed column operation and are not suitable for flow-through systems. Furthermore, NPs tend to aggregate; this phenomenon reduces their high surface area to volume ratio and subsequently reduces effectiveness. By appropriately dispersing metal and metal oxides NPs into synthetic and naturally occurring polymers, many of the shortcomings can be overcome without compromising the parent properties of NPs. An efficient and practical approach is, for example, to incorporate NPs into spherical polymer structures or resins, such as ion exchange resins and chelating resins. It is unexpected that there is an approach to contemplate a hybrid particle composition, which can provide a dual function of disinfection though biological and chemical contaminants reduction from the contaminated fluid.

The term “contaminants” can mean chemical contaminants and or biological contaminants from a contaminated fluid. In some embodiments, the biological contaminants include bacteria, virus, fungus, or algae. In some embodiments, the chemical contaminants will include without being limited to: organic compounds, residual halogen, selenium, arsenate, arsenite, fluoride, dichromate, manganese, tin, platinum, iron, cobalt, chromate, molybdate, selenite, selenate, nitrate, phosphate, borate, uranium, vanadium, vanadate, ruthenium, antimony, molybdenum, tungsten, barium, cerium, lanthanum, zirconium, titanium, and or radium, zinc, copper, lead, mercury, cadmium, as well as natural organic matter (NOM, such as tannins, fulvic acid or humic acid), pesticide and herbicide residues, endocrine disruptors, pharmaceutical residues and organic compounds released through industrial discharges.

The term “contaminated fluid” refers to air, water or aqueous that contains the chemical or biological contaminants.

The term “water purification” refers to a process of removing undesirable chemicals, biological contaminants, suspended solids and gases from contaminated water. The objective of this process is to produce water fit for a specific purpose, such as human drinking, or medical, pharmacological, chemical and industrial applications.

The term “water remediation” refers to a process of removing pollutants from the polluted water or waste water from industrial manufacture processes, or from the polluted municipal or agricultural water sources.

As used herein, “halogenated polystyrenehydantoin” refers to the N-halamine polymers named poly-1,3-dihalo-5-methyl-5-(4′-vinylphenyl)hydantoin, poly-1-halo-5-methyl-5-(4′-vinylphenyl)hydantoin, and the alkali salt derivative of the monohalo species, and mixtures thereof, wherein the halogen can be either chlorine or bromine, although this is not meant to be limiting, as any other insoluble N-halamine polymer beads, porous or nonporous, could provide some degree of disinfection or biocidal capacity.

As used herein, “bead,” in singular or plural, can be of any size or shape, including spheres so as to resemble beads, but may also include irregularly shaped particles. “Bead” is used interchangeably with particle.

As used herein, “hybrid particle” refers to a nanocomposite particle comprising of a polymer with N-halamines or precursor N-halamine, such as polystyrenehydantoin or methylated polystyrene or halogenated polystyrenehydantoin or any methylated polystyrene or any of the halogenated forms of methylated polystyrene or other cyclic amine and N-halamine polymers, and nanoparticles. Hybrid particle can be referred to as a polymeric hybrid particle or as a composition.

As used herein, “nanoparticles” refers to particles having particle size in the range of 1 to 500 nanometers, preferably, 1 to 200 nanometers, more preferably, 1 to 100 nanometers, such as nano metal particles, or nano metal oxides particles, or others. In some embodiments, nanoparticles are adsorbents. In some embodiments, nanoparticles are linked to polymers, such as the halogenated or nonhalogenated polystyrenehydantoin particles or beads or any of the methylated polystyrenes or other cyclic amine and N-halamine polymers.

One embodiment provided is a polymeric hybrid particle or composition comprising of polystyrenehydantoin, and nanoparticles (NPs), having the following chemical formula.

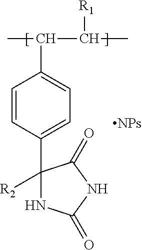

In some embodiments, the polystyrenehydantoin particles are made from crosslinked polystyrene particles. The polystyrenehydantoin particles are further described in U.S. Pat. No. 6,548,054, incorporated herein by reference in its entirety. The commercially available polystyrenehydantoin particle product is produced by HaloSource Inc., a Seattle-based company. The amount of crosslinking from initial crosslinked polystyrene particles is not less than 3%, and R₁ is H or methyl (CH₃); R₂ is C₁-C₈ alkyl or phenyl groups. NPs refers to nanoparticles chosen from nano iron oxides, nano iron oxyhydroxides, nano hydrated ferric oxides (HFO), nano titanium oxides, nanoalumina, nano zirconium oxide, nano cerium oxide, nano manganese oxides, nano zinc oxides, nano magnetic iron oxides or any combination of thereof. In some embodiments, the nanoparticles function as adsorbents for a plurality of chemical compounds.

One embodiment provided is a polymeric hybrid particle or composition comprising of halogenated polystyrenehydantoin, and nanoparticles (NPs), having the following chemical formula.

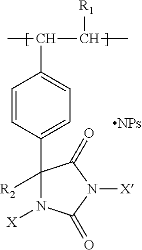

In some embodiments, the halogenated polystyrenehydantoin particles are made from crosslinked polystyrene particles. The halogenated polystyrenehydantoin particles are further described in U.S. Pat. No. 6,548,054, incorporated herein by reference in its entirety. The commercially available halogenated polystyrenehydantoin particle product, under registered trade name HaloPure or HaloPure Br, is produced by HaloSource Inc., a Seattle-based company. The amount of crosslinking from initial crosslinked polystyrene particles is not less than 3%, and R₁ is H or methyl (CH₃); R₂ is C₁-C₈ alkyl or phenyl groups, X and X′ are independently chlorine (Cl), bromine (Br), or hydrogen (H), provided that at least one of X and X′ is Cl or Br. NPs refers to nanoparticles chosen from nano iron oxides, nano iron oxyhydroxides, nano hydrated ferric oxides (HFO), nano titanium oxides, nanoalumina, nano zirconium oxide, nano cerium oxide, nano manganese oxides, nano zinc oxides, or any combination of thereof. In some embodiments, the nanoparticles function as adsorbents for a plurality of chemical compounds.

In some embodiments a polymeric hybrid particle or composition comprises a methylated polystyrene and nanoparticles (NPs) according to the following structures.

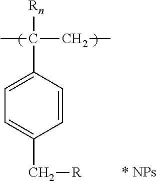

wherein R is selected from one or more of the following:

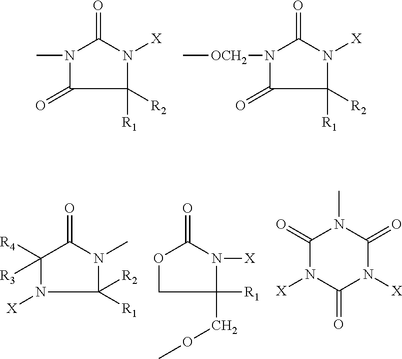

wherein,

Rₙ is a hydrogen or a C₁-C₈ alkyl or phenyl group;

R₁, R₂, R₃ and R₄ are a C₁-C₈ alkyl or phenyl group;

X is chlorine, bromine, or hydrogen; and

NPs are nanoparticles. NPs can be chosen from nano iron oxides, nano iron oxyhydroxides, nano hydrated ferric oxides (HFO), nano titanium oxides, nanoalumina, nano zirconium oxide, nano cerium oxide, nano manganese oxides, nano zinc oxides, nano magnetic iron oxides or any combination of thereof. In some embodiments, the nanoparticles function as adsorbents for a plurality of chemical compounds.

Further, in other embodiments, R₁, R₂, R₃, and R₄ are independently selected from C₁-C₄ alkyl, phenyl, or aryl; X is hydrogen, chlorine, or bromine, at least one of which must be chlorine or bromine when the compound is a biocidal N-halamine, X is not chlorine or bromine for precursor N-halamine. “Independently selected” encompasses all the combinations of the one or more R₁, R₂, R₃, and R₄ groups possible with the moieties selected from C₁-C₄ alkyl, phenyl and aryl. Thus, the R₁, R₂, R₃, and R₄ groups can all be the same group or can all be different groups or any other combination. The repeating unit appears consecutively if the polymeric compound is a homopolymer, or alternatively with one or more different repeating units if the polymeric compound is a copolymer. In some embodiments, the methylated polystyrene is crosslinked. In some embodiments, the methylated polystyrene with cyclic amines is made from chloromethylated polystyrene. The degree of crosslinking of the chloromethylated polystyrene can be in the range of from about 3 to about 10 weight percent for hardness and lack of solubility. In one embodiment, the degree of crosslinking is from about 5 to about 8 weight percent. There are many types of highly crosslinked, porous chloromethylated polystyrene beads that can be used in to make methylated polystyrene according to the above structures. In some embodiments, the crosslinked methylated polystyrene has pore sizes in the range of from about 10 to about 100 nm, more preferably, in the range of from about 30 to about 70 nm. Methylated polystyrenes are described in U.S. Pat. No. 7,687,072, which is fully incorporated herein by reference.

While the foregoing structures relate to polystyrene polymers linked to nanoparticles, other polymers may also be linked to nanoparticles. Generally, a polymer having precursor N-halamine groups or N-halamine groups can be linked with nanoparticles. In some embodiments, an N-halamine refers to a heterocyclic, monocyclic structure having a 4-7, and preferably 5-6, membered heterocyclic ring wherein the ring members are comprised of at least carbon and nitrogen provided there is at least one nitrogen heteroatom; wherein at least one carbon ring member can comprise a carbonyl group; and wherein one ring member can comprise oxygen; and wherein the balance of ring members is carbon. An N-halamine group additionally includes at least one halogen, preferably chlorine or bromine, bonded to one or more nitrogen heteroatoms. Substituent groups other than hydrogen can be linked to the carbon ring members. A precursor N-halamine is the group without halogens and can be referred to as a “cyclic amine”. Precursor N-halamine and N-halamine groups can be used as monomers for polymerization into polymers or copolymers when reacted with other monomers. Additionally, precursor N-halamine or cyclic amine and N-halamine groups can be grafted onto existing polymers, such as polystyrene or chloromethylated polystyrene, or other polymers. Examples of N-halamine and precursor N-halamine (cyclic amine) groups include imidazolidinone groups, oxazolidinone groups, isocyanurate groups, triazinedione groups, piperidine groups, hydantoin groups, and the 3-hydroxyalkylhydantoin group and their halogenated forms. In some embodiments, a polymer having one or more N-halamine or precursor N-halamine groups can be referred to as an N-halamine polymer when halogenated or precursor N-halamine polymer or cyclic amine polymer when not halogenated.

Polymers or materials to which precursor N-halamine or N-halamine groups, such as imidazolidinone groups, oxazolidinone groups, isocyanurate groups, triazinedione groups, piperidine groups, hydantoin groups, and the 3-hydroxyalkylhydantoin group, may be incorporated with include, but are not limited to, polyacrylonitrile, polystyrene, polyvinyl acetate, polyurethane, polyvinyl alcohol, polyvinyl chloride, polyester, polyamide, polyacrylic acid, polyacrylamine, polybutylene, polysiloxanes, elastomers, rubber, plastics, textiles, natural fibers, chitosan, and cellulose. Polymers may also be made through polymerization from monomers. Precursor N-halamine and N-halamine monomers can be copolymerized with themselves or other monomers, including, but not limited to acrylonitrile, styrene, vinyl acetate, and vinyl chloride monomers. In addition, the above polymers can be crosslinked with crosslinking agents, such as divinylbenzene, melamine, and the like. The above listed polymers can be linked to nanoparticles in the manner described herein.

U.S. Pat. No. 6,294,185, incorporated herein by reference, discloses the following examples of precursor N-halamine polymers and N-halamine polymers, which may also be linked to nanoparticles.

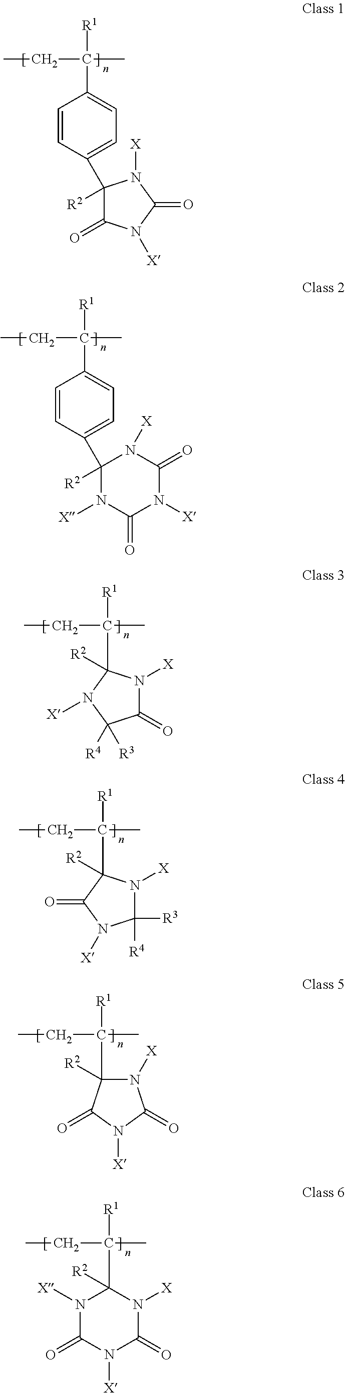

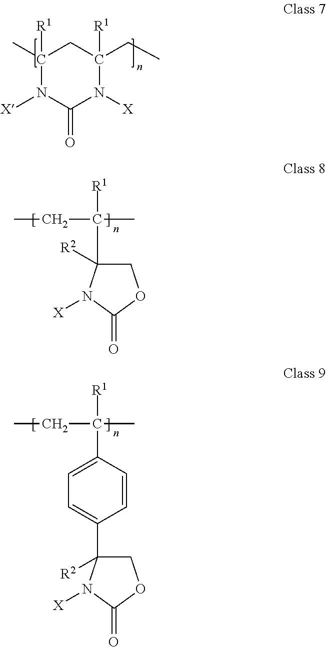

Wherein in each class X, X′ and X″ can be hydrogen atoms; wherein R¹ is selected from the group consisting of hydrogen or from C₁ to C₄ alkyl; R² is selected from the group consisting of from C₁ to C₄ alkyl, benzyl, or substituted benzyl; R³ and R⁴ are selected from the group consisting of from C₁ to C₄ alkyl, phenyl, substituted phenyl, benzyl, substituted benzyl, or R³ and R⁴ may represent spirosubstitution by a component selected from the group consisting of pentamethylene and tetramethylene; or wherein in each class X, X′, and X″ are halogen selected from the group consisting of chlorine, bromine, and mixtures thereof, or X, X′, and X″ may be hydrogen provided that at least one of these is halogen selected from the group consisting of chlorine and bromine; wherein R¹ is selected from the group consisting of hydrogen or from C₁ to C₄ alkyl; R² is selected from the group consisting of from C₁ to C₄ alkyl, benzyl, or substituted benzyl; R³ and R⁴ are selected from the group consisting of from C₁ to C₄ alkyl, phenyl, substituted phenyl, benzyl, substituted benzyl, or R³ and R⁴ may represent spirosubstitution by a component selected from the group consisting of pentamethylene and tetramethylene.

The alkyl substituents representing R¹, R², R³, and R⁴ or those attached to phenyl or benzyl may contain from 1 to 4 carbon atoms, including methyl, ethyl, propyl, isopropyl, n-butyl, isobutyl, secondary butyl, and tertiary butyl.

Examples of each class of Precursor N-halamine polymer (cyclic amine polymer) include but are not limited to:

Class 1: poly-5-methyl-5-(4′-vinylphenyl)hydantoin; poly-5-methyl-5-(4′-isopropenylphenyl)hydantoin;

Class 2: poly-6-methyl-6-(4′-vinylphenyl)-1,3,5-triazine-2,4-dione; poly-6-methyl-6-(4′-isopropenylphenyl)-1,3,5-triazine-2,4-dione;

Class 3: poly-2,5,5-trimethyl-2-vinyl-1,3-imidazolidin-4-one;

Class 4: poly-2,2,5-trimethyl-5-vinyl-1,3-imidazolidin-4-one;

Class 5: poly-5-methyl-5-vinylhydantoin;

Class 6: poly-6-methyl-6-vinyl-1,3,5-triazine-2,4-dione;

Class 7: poly-(4-methylene-6-yl)-4,6-dimethyl-3,4,5,6-tetrahydro(1H)pyrimidin-2-one;

Class 8: poly-4-methyl-4-vinyl-2-oxazolidinone;

Class 9: poly-4-methyl-4-(4′-vinylphenyl)-2-oxazolidinone.

Polymers such as the above listed can be used to prepare compositions with nanoparticles.

Examples of biocidal N-halamine polymers include but are not limited to:

Class 1: poly-1,3-dichloro-5-methyl-5-(4′-vinylphenyl) hydantoin; poly-1,3-dichloro-5-methyl-5-(4′-isopropenylphenyl)hydantoin; poly-1-chloro-5-methyl-5-(4′-vinylphenyl)hydantoin; poly-1-chloro-5-methyl-5-(4′-isopropenylphenyl)hydantoin; poly-1,3-dibromo-5-methyl-5-(4′-vinylphenyl)hydantoin; poly-1,3-dibromo-5-methyl-5-(4′-isopropenylphenyl)hydantoin; poly-1-bromo-3-chloro-5-methyl-5-(4′-vinylphenyl)hydantoin and poly-1-bromo-3-chloro-5-methyl-5-(4′-isopropenylphenyl)hydantoin;

Class 2: poly-1,3,5-trichloro-6-methyl-6-(4′-vinylphenyl)-1,3,5-triazine-2,4-dione; poly-1,3,5-trichloro-6-methyl-6-(4′-isopropenylphenyl)-1,3,5-triazine-2,4,-dione; poly-1,5-dichloro-6-methyl-6-(4′-vinylphenyl)-1,3,5-triazine-2,4-dione; poly-1,5-dichloro-6-methyl-6-(4′-isopropenylphenyl)-1,3,5-triazine-2,4-dione; poly-1,3,5-tribromo-6-methyl-6-(4′-vinylphenyl)-1,3,5-triazine-2,4-dione; poly-1,3,5-tribromo-6-methyl-6-(4′-isopropenylphenyl)-1,3,5-triazine-2,4-dione; poly-1-bromo-3,5-dichloro-6-methyl-6-(4′-vinylphenyl)-1,3,5-triazine-2,4-dione; and poly-1-bromo-3,5-dichloro-6-methyl-6-(4′-isopropenylphenyl)-1,3,5-triazine-2,4-dione;

Class 3: poly-1,3-dichloro-2,5,5-trimethyl-2-vinyl-1,3-imidazolidin-4-one;

Class 4: poly-1,3-dichloro-2,2,5-trimethyl-5-vinyl-1,3-imidazolidin-4-one;

Class 5: poly-1,3-dichloro-5-methyl-5-vinylhydantoin; poly-1-chloro-5-methyl-5-vinylhydantoin; poly-1,3-dibromo-5-methyl-5-vinylhydantoin; and poly-1-bromo-3-chloro-5-methyl-5-vinylhydantoin;

Class 6: poly-1,3,5-trichloro-6-methyl-6-vinyl-1,3,5-triazine-2,4-dione;

Class 7: poly-1,3-dichloro-(4-methylene-6-yl)-4,6-dimethyl-3,4,5,6-tetrahydro(1H)pyrimidin-2-one; poly-1-chloro-(4-methylene-6-yl)-4,6-dimethyl-3,4,5,6-tetrahydro(1H)pyrimidin-2-one; poly-1,3-dibromo-(4-methylene-6-yl)-4,6-dimethyl-3,4,5,6-tetrahydro(1H)pyrimidin-2-one; and poly-1-bromo-3-chloro-(4-methylene-6-yl)-4,6-dimethyl-3,4,5,6-tetrahydro(1H)pyrimidin-2-one;

Class 8: poly-3-chloro-4-methyl-4-vinyl-2-oxazolidinone; and

Class 9: poly-3-chloro-4-methyl-4-(4′-vinylphenyl)-2-oxazolidinone.

By substitution of other named substituents for R¹, R², R³, and R⁴, e.g., ethyl, propyl, phenyl, etc., for one or more of the derivatives above named, other correspondingly named N-halo or unhalogenated derivatives may be formed.

Polymers such as the above listed can be used to prepare hybrid particles or compositions with nanoparticles.

In some embodiments, a polymeric hybrid particle or composition comprising of polymers, such as polystyrenehydantoin or methylated polystyrene or their halogenated forms or other cyclic amine and N-halamine polymers, and nanoparticles, has a particle shape in the form of a bead. However, other embodiments can provide the hybrid particles in any other shape. In one instance the bead is greater than 100 micron or from about 100 micron to about 1500 micron.

In some embodiments, a polymeric hybrid particle or composition comprising of polymers, such as polystyrenehydantoin or methylated polystyrene or their halogenated forms or other cyclic amine and N-halamine polymers, and nanoparticles, can have pores, wherein the average of the pore size is greater than about 1 nm or from about 1 nm to 100 nm.

In one embodiment, the halogenated polystyrenehydantoin particles have highly crosslinked N-halamine polymers of poly-1,3-dihalo-5-methyl-5-(4′-vinylphenyl)hydantoin, poly-1-halo-5-methyl-5-(4′-vinylphenyl)hydantoin, and the alkali salt derivative of the monohalo species, and mixtures thereof, wherein the alkali salt can be any of sodium, potassium, magnesium, calcium, and halogen can be either chlorine or bromine or both.

In one embodiment, a polymeric hybrid particle or composition comprises polymers, such as polystyrenehydantoin or methylated polystyrene or their halogenated forms or other cyclic amine and N-halamine polymers, and nanoparticles, wherein, the nanoparticles' size is in the range of 1 nanometer to 500 nanometers in size; preferably, 1 nanometer to 200 nanometers; more preferably, 1 nanometer to 100 nanometers.

It should be understood that the hybrid particles or compositions made in accordance with the invention can be created in a variety of sizes or shapes dependent upon the particle size or shape of the starting crosslinked polystyrene material for making the polystyrenehydantoin particle.

In some embodiments, the hybrid particles or beads or compositions are porous and have high surface areas to some degree allowing more efficient interaction with chemical contaminants and or bacteria/viruses from a contaminated fluid. For the practical applications contemplated herein, the particle size of the hybrid beads can be in the range of about 100 to 1500 microns, or in the range of 300 to 1200 microns. This particle size provides adequate hydraulic flow characteristics for treating the contaminated fluid for the purpose of contaminants removal. In one instance, when the hybrid beads are used in a gravity-fed or a low-pressure-fed, or a large scale-based industrial water treatment application, the particle size will factor in determining the flow rate. For the applications contemplated herein, the hybrid beads can also have pore sizes in the range of about 1 to 100 nm, or in the range of about 1 to 70 nm. A porous structure provides additional surface area for the hybrid beads to more efficiently interact with chemical contaminants and or bacteria/viruses from a contaminated fluid. It is further contemplated herein that the hybrid beads should have a suitable physical strength for a practical application, the crosslinking degree of the starting polystyrene material for making polystyrenehydantoin should be in the range of about 2 to 15 weight percent, or about 3 to 10 weight percent.

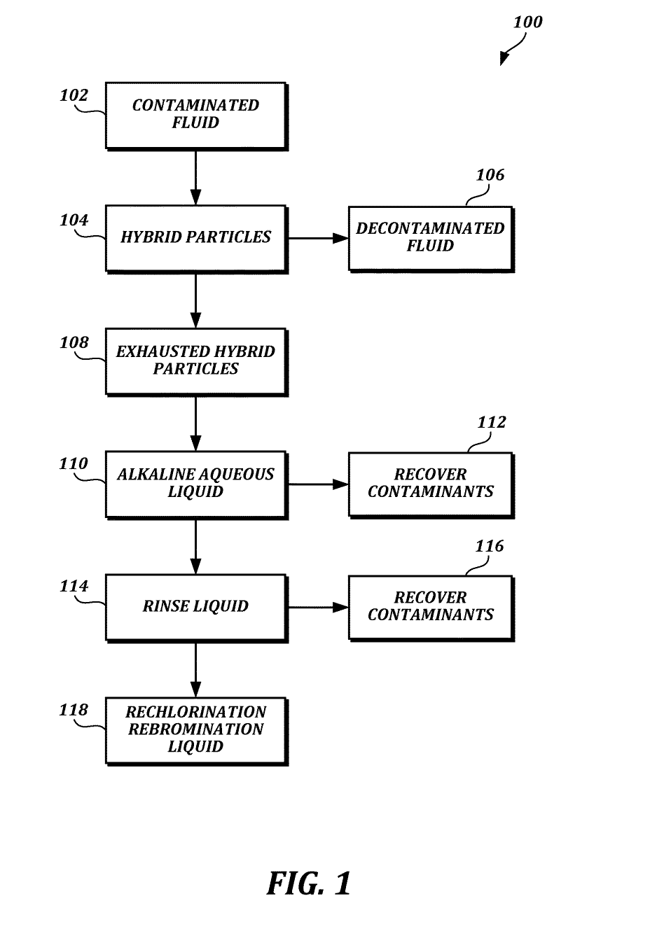

FIG. 1 illustrates a flow diagram of a method of using the hybrid particles or compositions to remove contaminants from contaminated fluids and or to inactivate microorganisms, which can then be followed by additional steps for regenerating the hybrid beads.

Referring to FIG. 1, a contaminated fluid of step 102 having any of the chemical or biological contaminants herein described is brought into contact with the hybrid particles or compositions in step 104, resulting in the decontaminated fluid of step 106. The contaminants can include microorgansims as well chemicals. The polymers of the hybrid particles inactivate the biological contaminants and the nanoparticles remove the chemical contaminants. Accordingly, the hybrid particles can treat fluids containing biological, chemical, or both biological and chemical contaminants.

An advantage of the hybrid particles or compositions is the ability to be regenerated by performing step 110, step 114, and step 118. Steps 110 and 114 may be particularly suited to regenerating the nanoparticles of the hybrid particles, while step 118 is particularly suited to regenerating the polymers of the hybrid particles.

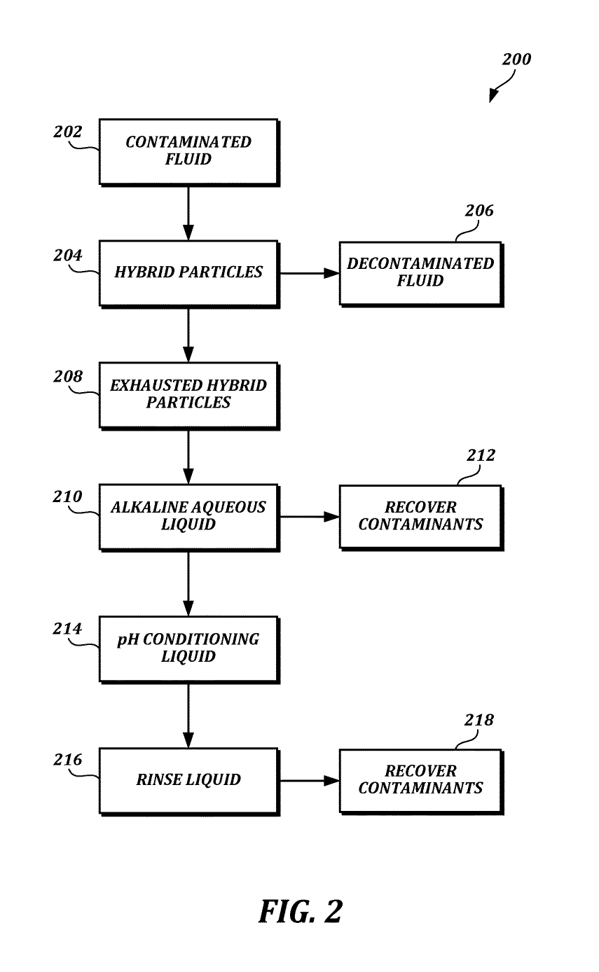

Referring to FIG. 2, a contaminated fluid of step 202 having any of the chemical or biological contaminants herein described is brought into contact with the hybrid particles or compositions in step 204, resulting in the decontaminated fluid of step 206. The contaminants can include microorgansims as well chemicals. The polymers of the hybrid particles inactivate the biological contaminants and the nanoparticles remove the chemical contaminants. Accordingly, the hybrid particles or compositions can treat fluids containing biological, chemical, or both biological and chemical contaminants.

An advantage of the hybrid particles or compositions is the ability to be regenerated by performing step 210, step 214, and step 218. Steps 210, 214, and step 218 may be particularly suited to regenerating the nanoparticles of the hybrid particles.

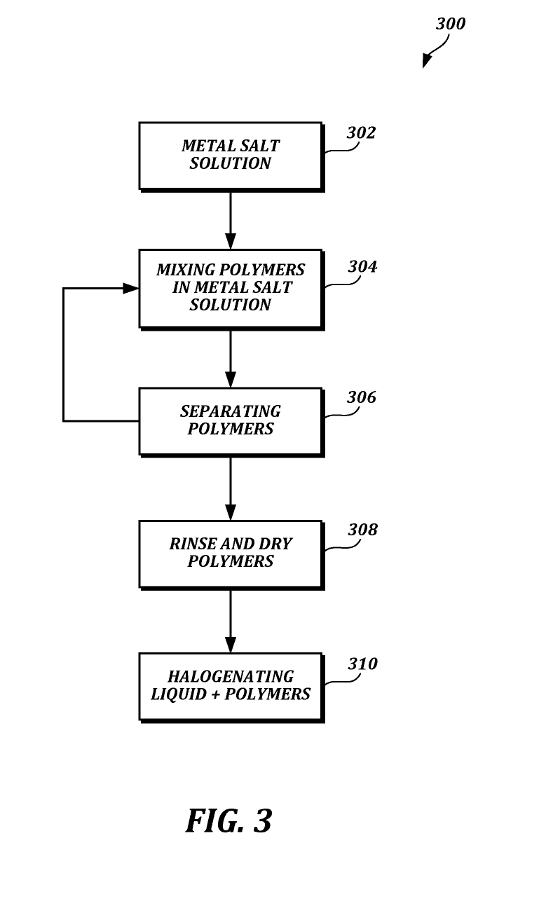

Referring to FIG. 3, one embodiment for preparing the hybrid particles or compositions is illustrated.

In step 302, a metal salt solution is prepared by dissolving a water soluble metal salt or salts in water, or in C₁-C₃ alcohol or in the mixture of water and C₁-C₃ alcohol, wherein, a water-soluble metal salt or salts can be chosen from ferric salt, aluminum salt, zirconium salt, manganese salt, zinc salt, alkoxides of titanium(IV) or titanium(IV) oxysulfate, or any combinations of them.

In step 304, polymers, such as polystyrenehydantoin particles or beads, are suspended in the metal salt-containing solution, and maintaining mixing from 1 to 20 hours with the pH maintained in the range of 2 to 9. Then, in step 306, the beads are separated by filtration.

After separating the particles in step 306, the particles are returned to the metal salt-containing solution in step 304 for 0 to 8 cycles. Thereafter, the particles or beads are separated again and rinsed by water, dried at a temperature from ambient temperature to 150° C. in step 308. After step 308, the hybrid particles contain both the polymers and the nanoparticles in a linked relationship. However, the polymers are not halogenated. In step 310, the hybrid particles may undergo an additional mixing with a halogenating liquid to load chlorine or bromine onto the precursor N-halamine groups in the polymers.

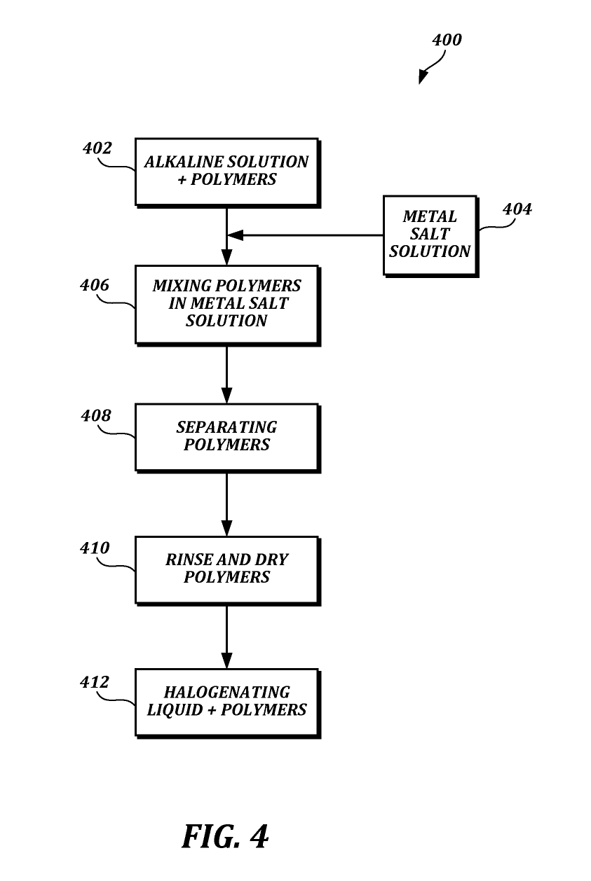

Referring to FIG. 4, one embodiment for preparing the hybrid particles or compositions is illustrated.

In step 402, polymers, such as polystyrenehydantoin alkali salt particles or beads, are prepared by mixing polystyrenehydantoin in an alkaline solution made from an alkali base or salt with water or water miscible organic solvent, and followed by separation and cycles of rinse. The alkali base or salt can be chosen from sodium, potassium, magnesium, and calcium, some examples include without being limited to: sodium hydroxide, potassium hydroxide, magnesium hydroxide, calcium hydroxide, sodium carbonate, potassium carbonate, et al. The imide-hydrogen of 3-position of hydantoin ring from polystyrenehydantoin can be neutralized by alkaline and further converted into a salt.

In step 404, a metal salt solution is prepared by dissolving a water soluble metal salt or salts in water, or in C₁-C₃ alcohol or in the mixture of water and C₁-C₃ alcohol. The water-soluble metal salt or salts can be chosen from ferric salt, aluminum salt, zirconium salt, manganese salt, zinc salt, alkoxides of titanium(IV) or titanium(IV) oxysulfate, or any combinations of them.

In step 406, the polystyrenehydantoin alkali salt particles or beads from step 402 are suspended in the metal salt-containing solution from step 404, and maintaining mixing from 1 to 20 hours with the pH maintained in the range of 2 to 9. Afterwards, the beads are separated by filtration in step 408.

After separation, the particles can re-introduced in the metal salt containing solution in step 406 and the cycle can be repeated 0 to 8 times. Thereafter, the particles or beads are separated again and rinsed in water and dried at a temperature from ambient temperature to 150° C. in step 410. After step 410, the hybrid particles contain both the polymers and the nanoparticles in a linked relationship. However, the polymers are not halogenated. In step 412, the hybrid particles may undergo an additional mixing with a halogenating liquid to load chlorine or bromine onto the hydantoin groups in the polymers.

In some embodiments, the polymers may be halogenated first, otherwise, a method for making halogenated hybrid particles is similar to the method of FIG. 3.

A solution is made by dissolving a water soluble metal salt or salts in water; wherein, the water-soluble metal salt or salts are choosen from ferrous salt, ferric salt, aluminum salt, zirconium salt, manganese salt, zinc salt, alkoxides of titanium(IV) or titanium(IV) oxysulfate, or any combinations of them.

Then, halogenated polymers, such as the halogenated polystyrenehydantoin particles or beads, are suspended in the metal salt-containing solution, and maintaining mixing from 1 to 20 hours with the pH maintained in the range of 2 to 9. Then, the beads are separated by filtration.

Suspension in the metal salt containing solution and separation can be repeated for another 0-8 cycles. Then, the halogenated particles or beads are separated again and rinsed by water, dried at a temperature from ambient temperature to 60° C.

In FIGS. 3 and 4, the steps 310 and 412 may include exposing the polymeric hybrid particles or compositions to a source of hypochlorous acid (sodium hypochlorite, calcium hypochlorite, sodium dichloroisocyanurate, etc.) or hypobromous acid (sodium hypobromite, etc.) in an aqueous liquid. The temperature can be in the range of 0° C. to ambient temperature, and the reactions can be carried out in a reactor or in situ in a cartridge filter packed with the unhalogenated hybrid beads. Optionally, the percent halogen on the hybrid beads can be controlled by pH adjustments. For example, at pH 6-7 maximum halogenation is achieved; whereas, at pH near 12 a monohalogenated alkali metal salt is obtained. Intermediate pH's (7-11) provide mixtures of dihalo and monohalo derivatives. The pH adjustments can be made using acids such as hydrochloric or acetic or bases such as sodium hydroxide or sodium carbonate.

Representative methods of making methylated polystyrenes having pendant precursor N-halamine are as follows. In one embodiment, clean, highly crosslinked porous chloromethylated polystyrene beads are suspended in a medium, such as DMF. The chloromethylated polystyrene beads are reacted with an precursor N-halamine, such as 5,5-dimethylhydantoin, in the presence of an alkali metal carbonate, such as potassium carbonate, at a temperature from about 70° to about 120° C., preferably about 95° C., for about 12 to about 96 hours to yield the methylated polystyrene having pendant precursor N-halamine groups. The time for this reaction is typically 72 hours when an alkali metal carbonate is employed.

In an alternate embodiment, the alkali metal salt of the precursor N-halamine is prepared first by reacting an precursor N-halamine with an alkali metal base for from about 15 minutes to about two hours at a temperature of from about 25° to about 100° C. The alkali metal base is preferably a carbonate, a hydroxide, or a hydride, and includes an alkali metal chosen from sodium or potassium. The reaction time between the precursor N-halamine and chloromethylated polystyrene is reduced if the alkali metal salt of the N-halamine precursor is prepared first. The salt is then used in the subsequent reaction between the alkali metal salt of the precursor N-halamine with the chloromethylated polystyrene to yield the methylated polystyrene having pendant precursor N-halamine groups. The time and temperature for this subsequent reaction is from about 4 to about 96 hours at a temperature of from about 70° to about 120° C., but typically is about 12 hours or less. Thus, the overall preparation time can be reduced by employing the latter two-step reaction method. The isolated product beads made through either method are washed in boiling water for purification purposes. After having made the methylated polystyrene bead having pendant precursor N-halamine groups, an aqueous suspension of the bead is chlorinated or brominated to render the bead biocidal. Halogenation is accomplished by exposing the bead to a source of free chlorine (e.g., gaseous chlorine, sodium hypochlorite, calcium hypochlorite, sodium dichloroisocyanurate) or free bromine (e.g., liquid bromine, sodium bromide/potassium peroxymonosulfate) in aqueous base. If chlorine gas is used, the reactor is preferably chilled to about 10° C. to prevent undesirable side reactions. Ambient temperature can be employed for the other noted sources of free halogen, and the reactions can be carried out in a reactor or in situ in a cartridge filter packed with the unhalogenated precursor. Using these methods, typical loadings of about 6-7% by weight chlorine and about 8-9% by weight bromine on the beads are generally obtained.

The unhalogenated precursor N-halamine (cyclic amine) polymers of Classes 1-9 can be prepared from existing inexpensive commercial grade polymers. In the case of the structure represented above by class 1, commercial grade polystyrene or substituted polystyrenes can be reacted with acetyl chloride or acetic anhydride in the presence of aluminum trichloride as a catalyst in common solvents such as carbon disulfide, methylene chloride, carbon tetrachloride, excess acetyl chloride, or nitrobenzene in a Friedel Crafts acylation to produce a para-acylated polystyrene, followed by reaction with potassium cyanide and ammonium carbonate in common solvents such as ethanol or ethanol/water mixtures, acetamide, dimethylformamide, dimethylacetamide, or 1-methyl-2-pyrolidinone to produce the poly-5-methyl-5-(4′-vinylphenyl)hydantoin.

For the structure represented by class 2, the same acylated polystyrene or substituted polystyrenes as for the class 1 structure can be reacted with dithiobiuret in the presence of dry hydrogen chloride in a dioxane/ethanol solvent followed by oxidation of the dithione produced with hydrogen peroxide in the presence of sodium hydroxide to produce the poly-6-methyl-6-(4′-vinylphenyl)-1,3,5-triazine-2,4-dione.

For the structure represented by class 3, poly-alkylvinyl ketone can be reacted with ammonium sulfide and an appropriate dialkyl cyanohydrin in a solvent such as dioxane, tetrahydrofuran, chloroform, or methylene chloride to produce a poly-vinyl-1,3-imidazolidine-4-thione which can then be directly chlorinated in aqueous sodium hydroxide to produce the poly-1,3-dichloro-2-vinyl-1,3-imidazolidin-4-one.

For the structure represented by class 4, poly-alkyl vinyl ketone can be reacted with sodium cyanide in the presence of sulfuric acid and then ammonium sulfide and an appropriate ketone in a solvent such as dioxane. The poly-vinyl thione product obtained can then be directly chlorinated in aqueous sodium hydroxide to produce the poly-1,3-dichloro-5-vinyl-1,3-imidazolidin-4-one.

For the structure represented by class 5, poly-alkyl vinyl ketone can be reacted with potassium cyanide and ammonium carbonate in solvent containing dioxane, ethanol, and water to produce a poly-5-alkyl-5-vinylhydantoin.

For the structure represented by class 6, poly-alkyl vinyl ketone can be reacted with dithiobiuret in the presence of hydrochloric acid followed by oxidation with hydrogen peroxide in the presence of sodium hydroxide to produce a poly-6-alkyl-6-vinyl-1,3,5-triazine-2,4-dione.

For the structure represented by class 7, poly-methacrylamide can be reacted with bromine in the presence of sodium hydroxide in a Hofmann degradation to produce a poly-diamine which can be reacted further with phosgene in the presence of toluene, water, and sodium hydroxide to produce poly-(4-methylene-6-yl)-4,6-dimethyl-3,4,5,6-tetrahydro(1H)pyrimidine-2-one.

For the structure represented by class 8, the monomer 4-methyl-4-vinyl-2-oxazolidinone obtained by reaction of phosgene with 2-amino-2-methyl-3-buten-1-ol can be polymerized and the resulting polymer then chlorinated in aqueous alkaline solution to produce the poly-3-chloro-4-methyl-4-vinyl-2-oxazolidinone.

For the structure represented by class 9, the monomer 4-methyl-4-(4′-vinylphenyl)-2-oxazolidinone obtained by reaction of phosgene with 2-amino-2-(4′-vinylphenyl)-1-propanol can be polymerized and the resulting polymer then chlorinated in aqueous alkaline solution to produce the poly-3-chloro-4-methyl-4-(4′-vinylphenyl)-2-oxazolidinone.

In some embodiments, a hybrid particle or composition comprising of polymers, such as polystyrenehydantoin or methylated polystyrene or their halogenated forms or other cyclic amine and N-halamine polymers, and nanoparticles, can be used for reduction of chemical contaminants including without being limited to, residual halogen (residual chlorine, residual chloramine, residual bromine, et al), selenium (such as selenite, selenate, et al), arsenic (such as arsenite, arsenate), fluoride, phosphate, chromium (chromate or dichromate), toxic cations (Co²⁺, Zn²⁺, Pb²⁺, Cd²⁺, Cu²⁺, Cs⁺, Cr³⁺, Hg²⁺, Ni²⁺, et al), and natural organic matters NOMs (such as tannins, fulvic acid or humic acid) from a contaminated fluid.

In some embodiments, a hybrid particle or composition comprising of polymers, such as polystyrenehydantoin or methylated polystyrene or their halogenated forms or other cyclic amine and N-halamine polymers, and nanoparticles, can also be formulated and or blended with other disinfection media, such as: iodine resin, HaloPure™ resin beads to provide a disinfection utility as well as a chemical reduction utility, such as reductions of chemical contaminants including without being limited to, residual halogen (residual chlorine, residual chloramine, residual bromine, et al), selenium (such as selenite, selenate, et al), arsenic (such as arsenite, arsenate), fluoride, phosphate, chromium (chromate or dichromate), toxic cations (Co²⁺, Zn²⁺, Pb²⁺, Cd²⁺, Cu²⁺, Cs⁺, Cr³⁺, Hg²⁺, Ni²⁺, et al), and natural organic matters NOMs (such as tannins, fulvic acid or humic acid).

In some embodiments, a hybrid particle or composition comprising of polymers, such as halogenated polystyrenehydantoin or methylated polystyrene or their halogenated forms or other cyclic amine and N-halamine polymers, and nanoparticles, can be used for both disinfection of microorganisms and reduction of chemical contaminants including without being limited to, residual halogen (residual chlorine, residual chloramine, residual bromine, et al), selenium (such as selenite, selenate), arsenic (such as arsenite, arsenate), fluoride, phosphate, chromium (chromate or dichromate), toxic cations (Co²⁺, Zn²⁺, Pb²⁺, Cd²⁺, Cu²⁺, Cs⁺, Cr³⁺, Hg²⁺, Ni²⁺, et al), and natural organic matters NOMs (such as tannins, fulvic acid or humic acid) from the contaminated water, etc.

Referring to FIG. 1, in some embodiments, after hybrid particles or compositions comprising of polymers, such as polystyrenehydantoin or methylated polystyrene or their halogenated forms or other cyclic amine and N-halamine polymers, and nanoparticles are exhausted by saturated exposure to chemical contaminants from the contaminated fluid, step 108, the particles can be further regenerated for reuse. In step 110, regeneration of exhausted beads can be achieved by simple exposure to alkaline aqueous liquids followed by rinsing using water or aqueous NaCl or aqueous KCl rinse solutions, step 114.

Referring to FIG. 1, in some embodiments, after hybrid particles or compositions comprising of polymers, such as halogenated polystyrenehydantoin or methylated polystyrene or other cyclic amine and N-halamine polymers, and nanoparticles, are exhausted by saturated exposure to chemical contaminants or biological contaminants (such as bacteria, viruses, fungus) from the contaminated fluid, step 108, the particles can be further regenerated for reuse. In step 110, regeneration of exhausted beads can be achieved by simple exposure to alkaline aqueous liquids, step 110, followed by rinsing using water or aqueous NaCl or aqueous KCl rinse solutions first, step 114, then further exposure to a sources of hypochlorous acid or hypobromous acid liquids for rechlorination or rebromination of the hybrid particles, step 118.

In some embodiments, the hybrid particles or compositions comprising of polymers, such as halogenated polystyrenehydantoin or methylated polystyrene or their halogenated forms or other cyclic or N-halamine polymers, and nanoparticles, can be employed in a filter for water or air disinfection and chemical contaminants reduction.

The biocidal hybrid particles will inactivate pathogenic microorganisms and viruses contained in water or air that comes in contact with the beads, and simultaneously will also remove the chemical contaminants contained in water or air media. Some examples of the chemical contaminants include, but are not limited to arsenic (arsenite, arsenate), selenium (selenite, selenite), fluoride, phosphate, chromium (chromate or dichromate), toxic cations (Co²⁺, Zn²⁺, Pb²⁺, Cd²⁺, Cu²⁺, Cs⁺, Cr³⁺, Hg²⁺, Ni²⁺, et al), and etc. In some applications, it is desirable to allow the contaminated fluid media to flow through and contact the beads.

In some embodiments, the hybrid particles or compositions comprising of polymers, such as polystyrenehydantoin or methylated polystyrene or their halogenated forms or other cyclic and N-halamine polymers, and nanoparticles, can be employed in a filter for water or air to remove chemical contaminants. The hybrid particles will remove the chemical contaminants contained in water or air media. Some examples of the chemical contaminants, include but are not limited to residual chlorine, residual chloramine, residual bromine, arsenic (arsenite, arsenate), selenium (selenite, selenate), fluoride, phosphate, chromium (chromate or dichromate), toxic cations (Co²⁺, Zn²⁺, Pb²⁺, Cd²⁺, Cu²⁺, Cs⁺, Cr³⁺, Hg²⁺, Ni²⁺, et al), and etc. In some applications, it is desirable to allow the contaminated fluid media to flow through and contact the beads.

A wide variety of filtration devices, including without being limited to: column filter, cartridge filter, or bed filter can be used that incorporate the hybrid particles or compositions, including very large units from industrial water treatment or small water treatment plants and in the air-handling systems of large aircraft, hotels, and convention centers, and small filters as might be employed in household carafes and for faucets and portable devices for backpacking and military field use.

Referring to FIG. 2, in some embodiments, after a hybrid particle or composition comprising of polymers, such as polystyrenehydantoin or methylated polystyrene or other cyclic amine and N-halamine polymers, and nanoparticles, are exhausted by saturated exposure to chemical contaminants from the contaminated fluid, step 208, the particles can be further regenerated for reuse. Regeneration of the exhausted hybrid particles includes exposure of the exhausted hybrid particles to an alkaline aqueous liquid with or without recirculation of the alkaline aqueous, step 210, and then followed by further conditioning the pH of exhausted hybrid particles to the pH in the range of 4 to 9, step 214, and then further rinsed by water, step 218. The alkaline aqueous liquid can be chosen from, but without being limited to: sodium hydroxide, potassium hydroxide, sodium carbonate, potassium carbonate, lithium hydroxide, calcium hydroxide, barium hydroxide, magnesium hydroxide, et al. and the alkaline aqueous can be made by simple dissolving an alkaline in water or C₁-C₃ alcohol or the combination of water and C₁-C₃ alcohol. In step 214, conditioning the pH of exhausted hybrid particles to a pH in the range of 4 to 9, can be achieved by further exposure of the hybrid particles to an aqueous buffer with or without recirculation contact among the particles and aqueous buffer. said the aqueous buffer has a pH in the range of 3 to 9, preferably, in the range of 4 to 8, more preferably, in the range of 5 to 7, and can be made by dissolving any combination of organic acid/inorganic acid/organic acid salt/inorganic acid salt. Some examples of buffers with pH of 4 to 9 include without being limited to: carbonic acid/bicarbonate; acetic acid/acetate; citric acid/citrate; phthalic acid/phthalic salt; et al. The regenerated hybrid particles will be available again for contaminants removal.

In FIGS. 1 and 2, in some embodiments, after hybrid particles or compositions comprising of polymers, such as polystyrenehydantoin or methylated polystyrene or other cyclic amine polymers, and nanoparticles, are exhausted by saturated exposure to chemical contaminants from the contaminated fluid, the particles can be further regenerated for reuse. During the regeneration procedure, some examples of contaminants including, but not limited to phosphate, selenium (such as selenite/selenite), or nitrate, can be further recovered by the regeneration. In steps 112 and 116 and steps 212 and 216 of FIGS. 1 and 2, respectively, the recovered contaminants in the alkaline aqueous liquid and the rinse liquid can further be collected and used as a raw material or side product. For example, the recovered selenite/selenite can be further purified/processed into sodium selenite which can be used in the manufacture of colorless glass, or used in some food supplements as an ingredient. Another example is to use the recovered nitrate, phosphate as a fertilizer produced from the regeneration procedure.

It will be understood that the specification and examples are illustrative but not limitative of the present invention and that other embodiments within the spirit and scope of the invention will suggest themselves to those skilled in the art.

### EXAMPLES

### Example 1

### Preparation of the Hybrid of Chlorinated Beads and Hydrated Ferric Oxides (HFO) Nanoparticles

### 1) Preparation of Chlorinated Polystyrenehydantoin (PSH) Beads

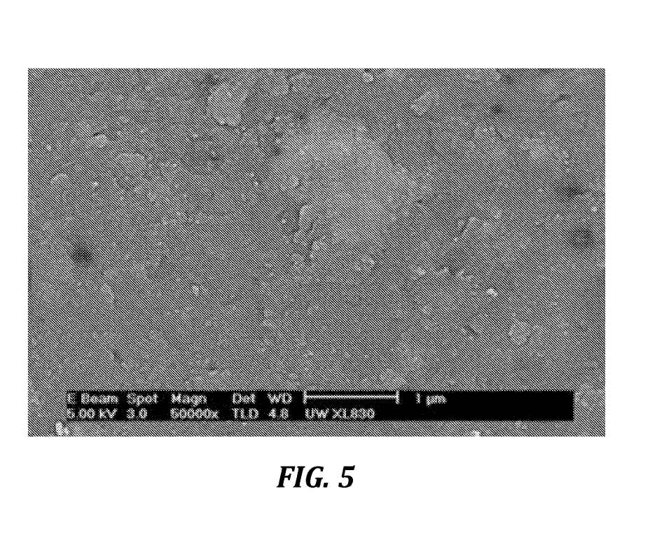

The crosslinked, porous polystyrenehydantoin (PSH) beads having 11.09% of nitrogen content with batch number 1108007 are supplied by HaloSource Inc. a Seattle-based company. Into 250 ml of beaker, 47.0 g of commercial bleach (12.7% of sodium hypochlorite) is first added, followed by adding 50 ml of deionized water, and then 10.0 g of PSH beads are added. Keep the mixture being stirred for 20 minutes at ambient temperature, then 1.0N of diluted sulfuric acid is added to the mixture dropwise until pH reaches to 9.5 and further maintain the pH between pH9.0 and pH9.5 with stirring for another 30 minutes. Finally, pH is adjusted to 8.0 and maintain the mixing for another 30 minutes. After the chlorination is completed, the beads are separated by filtration, and further washed for another 4 cycles using 200 ml of deionized water for each cycle, and dried at ambient temperature for overnight. An SEM of the crosslinked porous polystyrenehydantoin beads are shown in FIG. 5.

### 2) Preparation of the Hybrid of Chlorinated Beads and HFO Nanoparticles

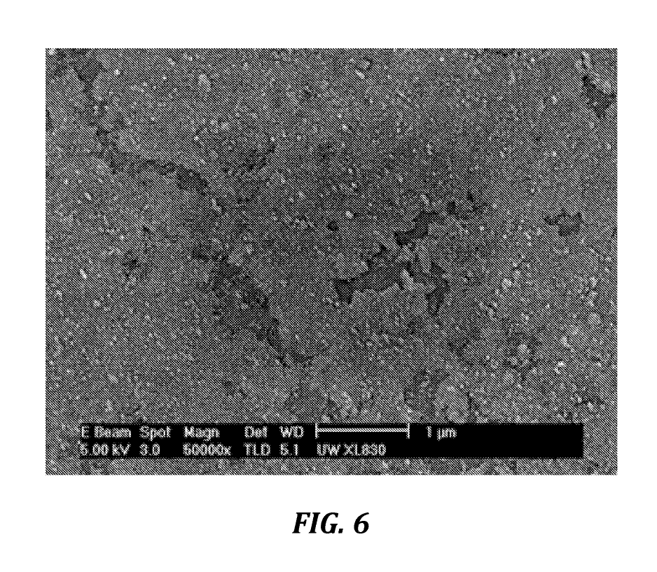

2.0% Ferrous solution is first prepared by dissolving 3.66 g of Ferrous Sulfate heptahydrate into 100 mL DI water. The whole chlorinated and dried PSH beads is soaked in 2.0% ferrous solution at ambient temperature, and the pH of the solution is adjusted to 6.5 by addition of 1.0M sodium hydroxide. The mixture continues being mixed for one hour around pH 6.5, then the beads are separated by filtration. Repeated this procedure for another 5 cycles. HFO amorphous nanoparticles-loaded beads are extracted in 300 mL DI water twice for 10 minutes, then separated by filtration and dried at ambient temperature for overnight. An infrared spectrum of a small sample of the beads (crushed to a fine powder) in a KBr pellet exhibited prominent bands at 1755 cm⁻¹ and 1804 cm⁻¹ in good agreement with that of chlorinated poly-1,3-dichloro-5-methyl-5(4′-vinylphenyl)hydantoin disclosed in U.S. Pat. No. 6,548,054. An iodometric/thiosulfate titration of weighed, crushed beads indicated that the hybrid beads contained 11.6% weight percent chlorine. Iron content in the hybrid beads is determined by following the procedure described in Food and Agriculture Organization of UN and published in FAO JECFA Monographs 5 (2008), consisting of Fe2O3 extraction/digestion process and followed by Iodometric titration. The final iodometric titration of weighed and crushed beads indicated the hybrid beads contained 9.9% weight percent iron. An SEM of the hybrid of chlorinated beads and hydrated ferric oxides (HFO) nanoparticles is shown in FIG. 6. An SEM image comparison of FIG. 5 with FIG. 6 indicated that the hydrated ferric oxides (HFO) nanoparticles are coated onto the chlorinated polystyrenehydantoin beads. The EDS results from the comparison of polystyrenehydantoin beads and the hybrid chlorinated polystyrenehydantoin beads shows that the surface of hybrid chlorinated beads contain 31.6% of iron, and also indicated the chlorine presence on the surface of the beads.

### Example 2

### Arsenate Removal Testing Using Hybrid of Chlorinated Beads Containing HFO Nanoparticles

The hybrid beads prepared from the above example 1 are further challenged by arsenate water in a mini column to test the arsenate reduction efficacy. 10 ml disposable pipet (VWR International) is filled with 9.0 ml of hybrid of chlorinated beads containing HFO nanoparticles. Another 10 ml of disposable pipet is filled with polystyrenehydantoin beads as a control. These columns are further connected with a pump to maintain the flow rate for arsenate reduction testing. 1 L of Ultra-Pure water is passed through these columns to condition the columns and ready for the test. The arsenate challenge water containing about 400 ppb arsenic (prepared by dissolving sodium arsenate heptahydrate into Ultra-Pure water). The pH of the test water is adjusted to 6.0 by adding 1.0N of diluted HCl acid, and the testing flow rate is maintained around 10 ml/min. The 1^{st} liter and the 2^{nd} liter of effluents from each column are collected separately for arsenate determination. The all arsenate-containing water samples are submitted for arsenate determination according to EPA 200.8, “Determination of Trace Elements in Water and Waste by Inductively Coupled Plasma-Mass Spectrometry.” The results exhibit that the hybrid of chlorinated beads containing hydrate ferric oxide (HFO) nanoparticles can reduce the As from 413 ppb in testing water down to 4.2 ppb (the 1^{st} liter of effluent) and 178 ppb (the 2^{nd} liter of effluent), however, the control sample polystyrenehydantoin beads do not reduce arsenate from testing water.

### Example 3

### Preparation of the Hybrid of Polystyrenehydantoin Beads and Hydrated Ferric Oxides (HFO) Nanoparticles

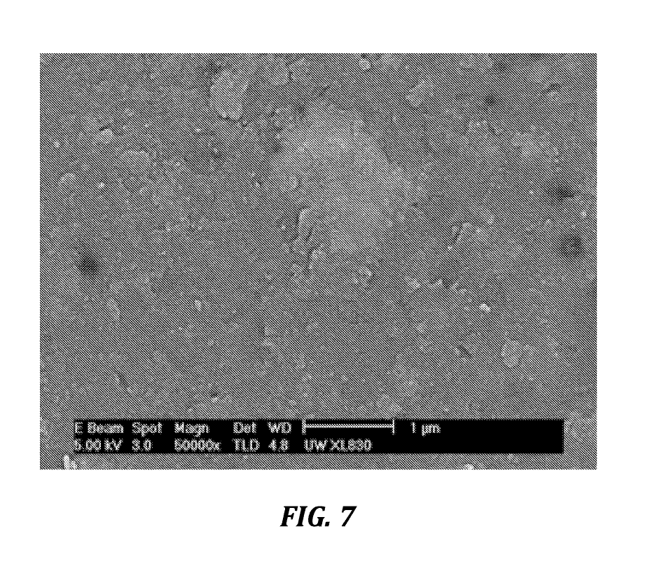

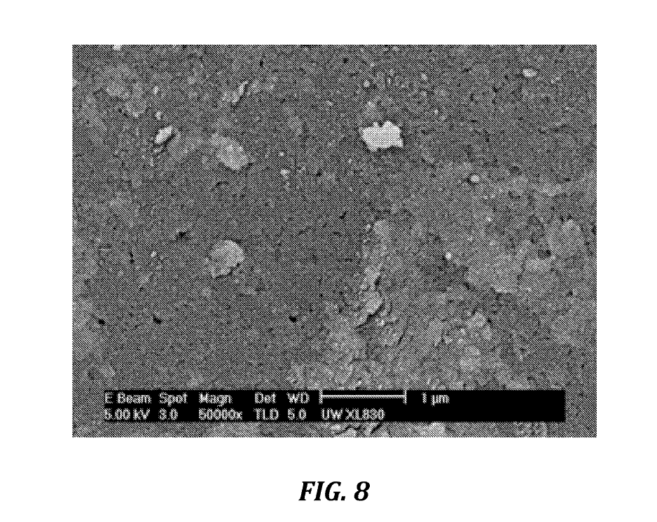

The crosslinked, porous polystyrenehydantoin (PSH) beads having 11.09% of nitrogen content with batch number 1108007 are supplied by HaloSource Inc. a Seattle-based company. Into 250 ml of beaker, 3.33 g of ferric chloride hexahydrate is dissolved in 100 ml of deionized water, followed by adding 10 g of polystyrenehydantoin beads and keep stirring at ambient temperature for 2 hours. 3.8M of sodium hydroxide solution is added into slowly by dropwise. After 8 hours mixing, the pH reaches to 3.7 and keep the mixing for overnight, and pH comes to 6.0, and continue the agitation while maintaining the pH in the range of 6.5 to 7.0. The beads are separated by filtration and dry at 50° C. oven for over night. The Iron content in the hybrid beads is determined by following the procedure described in Food and Agriculture Organization of UN and published in FAO JECFA Monographs 5 (2008), consisting of Fe2O3 extraction/digestion process and followed by Iodometric titration. The final iodometric titration of weighed and crushed beads indicated the hybrid beads contained 7.6% weight percent iron. FIG. 7 showing an SEM of polystyrenehydantoin beads compared to FIG. 8 showing an SEM of hybrid of polystyrenehydantoin beads and hydrated ferric oxide nanoparticles indicates that the hydrated ferric oxides (HFO) nanoparticles are coated onto the polystyrenehydantoin beads. The EDS results from the comparison of polystyrenehydantoin beads and the hybrid polystyrenehydantoin beads shows that the surface of hybrid beads contain 16.0% of iron, and also indicated the chlorine presence on the surface of the beads.

### Example 4

### Selenite Removal Testing of Hybrid of PSH Beads and HFO Nanoparticles

The hybrid beads prepared from the above example 3 are further challenged by selenite water in a mini column to test the selenite reduction efficacy. 10 ml disposable pipet (VWR International) is filled with 9.0 ml of hybrid of polystyrenehydantoin (PSH) beads containing HFO nanoparticles. Another 10 ml of disposable pipet is filled with PSH beads as a control. These columns are further connected with a pump to maintain the flow rate for selenite reduction testing. 1 L of Ultra-Pure water is passed through these columns to condition the columns and ready for the test. The selenite-containing challenge water having about 1000 ppb of selenite as Se (prepared by dissolving sodium selenite pentahydrate into Ultra-Pure water). The pH of the test water is adjusted to 6.0 by adding 1.0N of diluted HCl acid, and the flow rate is maintained around 10 ml/min for the column selenite reduction testing. The selenite-containing challenge water continues flow through the columns by pump till the capacity reaches 6 liters. The 1^{st} liter, the 2^{nd} liter and the 6^{th} liter of effluents from each column are collected separately for selenite determination. The all selenite-containing water samples are submitted for selenite determination according to EPA 200.8, “Determination of Trace Elements in Water and Waste by Inductively Coupled Plasma-Mass Spectrometry”. The results exhibit that the hybrid of PSH beads containing hydrate ferric oxide (HFO) nanoparticles can reduce the selenite from 1100 ppb as Se in testing water down to 17.5 ppb as Se (from the 1^{st} liter of effluent), 27.1 ppb as Se (from the 2^{nd} liter of effluent), and 186 ppb as Se (from the 6^{th} liter of effluent); however, the control sample polystyrenehydantoin beads can only reduce the selenite from 1100 ppb as Se in testing water down to 980 ppb as Se (from the 1^{st} liter of effluent), 1000 ppb as Se (from the 2^{nd} liter of effluent), and 1010 ppb as Se (from the 6^{th} liter of effluent). The results indicate that the hybrid of PSH beads containing hydrate ferric oxide (HFO) nanoparticles can effectively reduce selenite from the selenite-containing water, however, the control sample PSH does not efficiently to remove selenite from the testing water.

After the hybrid of PSH beads and HFO nanoparticles column is challenged by passing through 6 liters of selenite-containing testing water, for the purpose of regeneration of the columns, 250 ml of 1.0M of NaOH solution (prepared by dissolving sodium hydroxide in ultra-pure water) is pumped through each column at the flow rate of 7 ml/min, and 250 ml of effluent from each column is collected separately for selenite determination. Then these two columns are further rinsed with ultra-pure water first and followed with 500 ml of 0.85M of NaCl solution by passing them through each column at the flow rate of 7 ml/min. After these columns are regenerated as above described, the selenite-containing test water is passed through the columns again, and the 1^{st} of effluents from each column are collected separately for selenite determination by EPA 200.8 method. The results exhibit that the hybrid of PSH beads containing hydrate ferric oxide (HFO) nanoparticles can reduce the selenite from 1100 ppb as Se in testing water down to 70.8 ppb as Se (from the 1^{st} liter of effluent), and the control column filled with PSH beads does not reduce any selenite. However, the pH of effluents from the two columns both showed 10.0, which indicates the pH of these two columns are not fully conditioned during the regeneration and further optimized for the selenite reduction, because the preferred pH for selenite reduction is around 6.0. It can be predicted that if the final pH of regenerated hybrid beads can be further adjusted to around 6, the higher selenite reduction efficacy would be achieved. However, the results still demonstrates that column filled with the hybrid of PSH beads containing hydrate ferric oxide (HFO) nanoparticles can be regenerated for the selenite reduction when this hybrid media is used as a packed column or bed. The 250 ml of regeneration sodium hydroxide solution after passed through these columns indicate that the effluent from the column filled with the hybrid of PSH beads and HFO nanoparticles contains 19900 ppb of Se, and the column filled with PSH beads only contains 180 ppb of Se. The result demonstrates that the hybrid of PSH beads and HFO nanoparticles can efficiently adsorb or reduce selenite from the water, and the selenite can be further recovered by desorption of selenite from the nano hybrid beads. Therefore, this media can be used for not only removing selenite from water but also recovering selenite from the water.

### Example 5

### Preparation of the Hybrid of Brominated Polystyrenehydantoin Beads Containing HFO and Manganese Oxide Nanoparticles

The crosslinked, porous brominated polystyrenehydantoin beads having 14.0% of Br content by weight determined by iodometric/thiosulfate titration method, supplied as HPBR or HaloPure Br, by HaloSource Inc. a Seattle-based company. 2.47 g of ferrous sulfate heptahydrate and 1.80 g of manganese chloride tetrahydrate are first dissolved in 100 mL of deionized water. 10.0 g of HPBR is added to the mixture solution, and stirred for 1 hour, followed by adjusting to 6.0 using 3.8M of NaOH. Then the mixture is stirred for total 6 hours while maintaining the pH around 6.0. The beads are separated by filtration, and rinsed by deionized water, and dried at room temperature for overnight. The bead sample is crushed into fine powder and submitted for iron and manganese content determination by following EPA method 3050 (for sample preparation and digestion) and EPA method 6010 (analytical method). The results indicate that the final hybrid beads prepared as above have 3.39% of iron and 0.94% of manganese. The SEM/EDS result shows that the surface of the above-made hybrid beads have 27.2% Fe and 12.1% Mn. An iodometric/thiosulfate titration of weighed, crushed beads indicated that the hybrid beads contained 4.1% weight percent bromine.

### Example 6

### Phosphate Removal Testing of Hybrid of PSH Beads and HFO Nanoparticles

The hybrid beads prepared from the above example 3 are further challenged by phosphate-containing water in a mini column to test the phosphate reduction efficacy. 10 ml disposable pipet (VWR International) is filled with 9.0 ml of hybrid of polystyrenehydantoin (PSH) beads containing HFO nanoparticles. Another 10 ml of disposable pipet is filled with PSH beads as a control. These columns are further connected with a pump to maintain the flow rate for selenite reduction testing. 1 L of Ultra-Pure water is passed through these columns to condition the columns and ready for the test. The phosphate-containing challenge water having about 1000 ppb of phosphate is prepared by dissolving sodium phosphate dibasic into Ultra-Pure water and followed by adjusting pH to 6.0 using 1.0N of diluted HCl solution. The flow rate is maintained around 10 ml/min for the column phosphate reduction testing. The phosphate-containing challenge water continues flow through the columns by pump, then the 1^{st} liter, and the 2^{nd} liter of effluents from each column are collected separately for phosphate determination. The all phosphate-containing water samples are analyzed by HACH Method 8048, Phosphorus, Reactive (Orthophosphate), DR4000, using PhosVer 3 Phosphate Reagent Powder Pillows (Cat#21060-69). The results exhibit that the hybrid of PSH beads containing hydrate ferric oxide (HFO) nanoparticles can reduce the phosphate from 1140 ppb in testing water down to 5.0 ppb (from the 1^{st} liter of effluent), 3.0 ppb (from the 2^{nd} liter of effluent), however, the control sample polystyrenehydantoin beads cannot reduce any phosphate from the testing water. The results indicate that the hybrid of PSH beads containing hydrate ferric oxide (HFO) nanoparticles is highly effective to reduce phosphate from the testing water.

### Example 7

### Preparation of Chlorinated Polystyrenehydantoin and its Hybrid Beads Containing Hydrated Ferric Oxides (HFO) Nanoparticles

### 1) Preparation of Chlorinated Polystyrenehydantoin (PSH) Beads

The crosslinked, porous polystyrenehydantoin (PSH) beads having 11.33% of nitrogen content with batch number 1403034 are supplied by HaloSource Inc. a Seattle-based company. Into a jacketed reactor with overhead agitator equipped, 200 ml of deionized water and 1.0 gram of sodium bicarbonate (ACS grade) were added and stirred to completely dissolve. The temperature of the jacket reactor was controlled in the range of 4.0-5.0° C. 20.0 grams of PSH beads were added into the jacket reactor. A peristaltic metering pump was used to meter 120.0 grams of commercial bleach (12.7% of sodium hypochlorite, industrial grade) within 60 minutes. The pH of the mixture in the reactor was also controlled to around 7.0-7.5 by an auto pH adjustment metering pump which supplied 1.0N of sulfuric acid into the mixture of the reactor during the bleach addition time to consistently maintain the pH of mixture around 7.0-7.5. After 60 minutes of bleach addition was completed, the temperature of the mixture in the reactor was adjusted to 13.0° C., and maintained stirring for another 2 hours. The final beads were separated by filtration, and further transferred into 200 ml of deionized water and further mixed for 15 minutes to rinse off the residual bleach. Repeated the deionized water rinse step for another two cycles. The beads were separated by filtration and further air dried in the hood for overnight. The final porous poly-1,3-dichloro-5-methyl-5-(4′-vinylphenyl)hydantoin (Dichlor PSH) beads were obtained; an infrared spectrum of a small sample of the beads (crushed to a powder) in a KBr pellet exhibited prominent bands at 1752 and 1806 cm⁻¹, in good agreement with that of the powdered poly-1,3-dichloro-5-methyl-5-(4′-vinylphenyl)hydantoin porous beads disclosed in U.S. Pat. No. 6,548,054, indicative of an efficient heterogeneous reaction of chlorine with the insoluble, highly crosslinked, porous poly-5-methyl-5-(4′-vinylphenyl)hydantoin beads. An iodometric/thiosulfate titration of weighed, crushed beads indicated that the beads contained 18.0 weight percent chlorine.

2) Preparation of the Hybrid of HFO Nanoparticles and poly-1,3-dichloro-5-methyl-5-(4′-vinylphenyl)hydantoin Beads.

The crosslinked, porous polystyrenehydantoin (PSH) beads having 11.33% of nitrogen content with batch number 1403034 are supplied by HaloSource Inc. a Seattle-based company. Into 100 ml of beaker, 50 ml of 1M of sodium hydroxide solution were added, followed by adding 20.0 grams of PSH beads, after the mixture was mixed with overhead agitator at ambient temperature for 20 minutes, the beads were further separated by filtration. The separated beads were further added into the ferrous solution prepared by dissolving 10.98 grams of Ferrous sulfate heptahydrate in 50 ml deionized water, followed by 1 hour of mixing at ambient temperature. The beads were separated by filtration, and transferred into 200 ml of deionized water for another 15 minutes mixing, and separated by filtration. The ferrous treated beads were finally obtained.

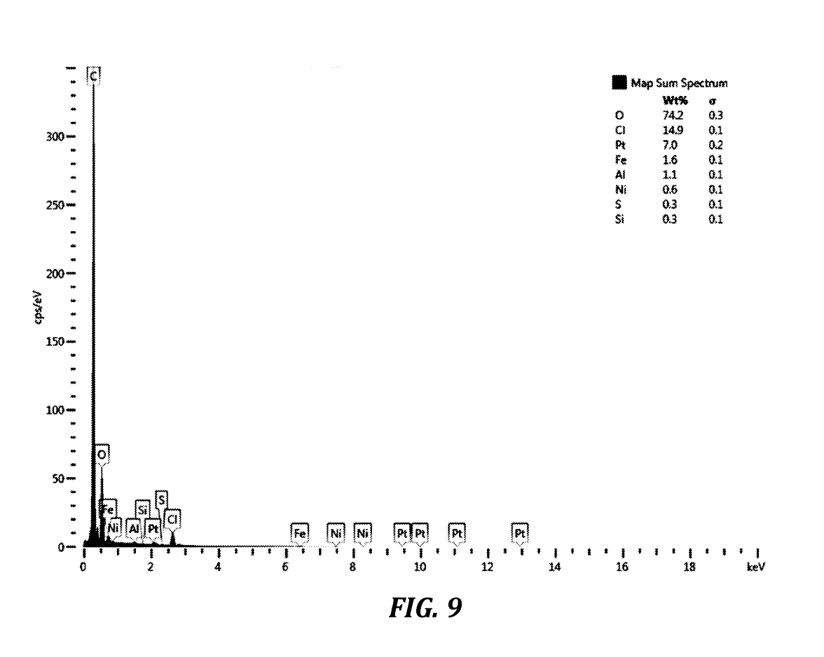

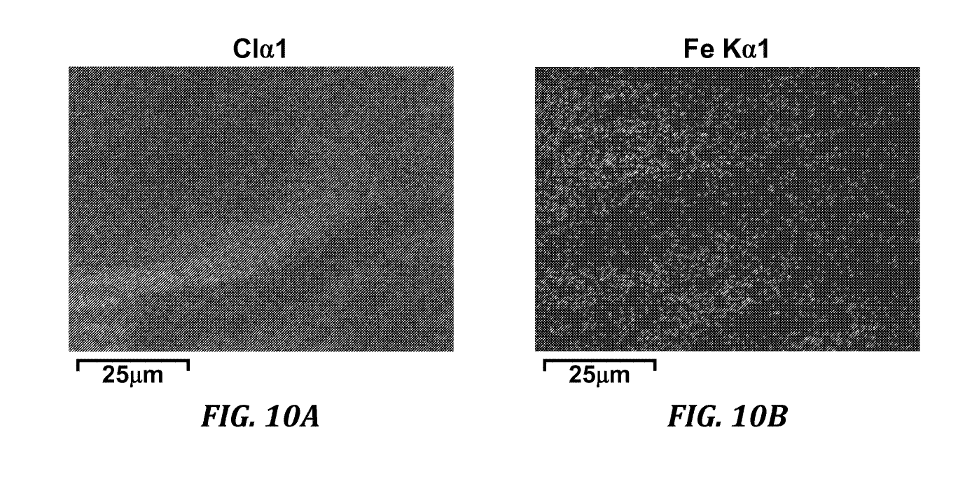

Into a jacketed reactor with overhead agitator equipped, 200 ml of deionized water were added. The temperature of the jacket reactor was controlled in the range of 4.0-5.0° C. The above ferrous treated beads were fully transferred into the jacket reactor. The mixture of the reactor was mixed with overhead agitator. A peristaltic metering pump was used to meter 150.0 grams of commercial bleach (12.7% of sodium hypochlorite, industrial grade) within 60 minutes. The pH of the mixture in the reactor was also controlled to around 6.5-7.0 by an auto pH adjustment metering pump which supplied 1.0N of sulfuric acid into the mixture of the reactor during the bleach addition time to consistently maintain the pH of mixture around 6.5-7.0. After 60 minutes of bleach addition was completed, the temperature of the mixture in the reactor was adjusted to 13.0° C., and maintained the stirring for another 2 hours. The final beads were separated by filtration, and further transferred into 200 ml of deionized water and further mixed for 15 minutes to rinse off the residual bleach. Repeated the deionized water rinse step for another two cycles. The beads were separated by filtration and further air dried in the hood for overnight. The final porous hybrid of HFO nanoparticles and poly-1,3-dichloro-5-methyl-5-(4′-vinylphenyl)hydantoin beads (Dichlor PSH & HFO hybrid) were obtained. An infrared spectrum of a small sample of the beads (crushed to a fine powder) in a KBr pellet exhibited prominent bands at 1752 cm⁻¹ and 1806 cm⁻¹ in good agreement with that of chlorinated poly-1,3-dichloro-5-methyl-5(4′-vinylphenyl)hydantoin disclosed in U.S. Pat. No. 6,548,054. An iodometric/thiosulfate titration of weighed, crushed beads indicated that the hybrid beads contained 18.0% weight percent chlorine. Iron content in the hybrid beads is determined by following the procedure described in Food and Agriculture Organization of UN and published in FAO JECFA Monographs 5 (2008), consisting of Fe₂O₃ extraction/digestion process and followed by Iodometric titration. The final iodometric titration of weighed and crushed beads indicated the hybrid beads contained 5.1% weight percent iron. A small sample of Dichlor PSH & HFO hybrid beads were crushed with motor and pestle in order to scan the internal surface of the beads using EDS (Energy Dispersive Spectroscopy), and Pt coating was applied to the crushed hybrid bead sample for EDS analysis. FIG. 9 is an EDS map sum spectrum showing that the Dichlor HFO hybrid contains 1.6% of iron, and 14.9% of chlorine. A scanned EDS layered image also indicated the chlorine (FIG. 10A) and iron (FIG. 10B) are both pretty evenly distributed in the internal surface of the hybrid beads.

### Example 8

### Biocidal Efficacies of Dichlor PSH & HFO Hybrid Against S. aureus

The beads (Dichlor PSH and Dichlor PSH & HFO hybrid) as prepared in Example 7 were tested for biocidal activity against S. aureus contained in water. In one test, about 3.9 g (6.1 ml of bulk volume) of Dichlor PSH & HFO hybrid beads were packed into a glass column having inside diameter 1.3 cm to a length of about 7.6 cm. In another test, about 3.5 g (6.1 ml of bulk volume) of Dichlor PSH beads were packed into a glass column having inside diameter 1.3 cm to a length of about 7.6 cm. In one control column, 6.1 mL of bulk volume of unchlorinated polystyrenehydantoin beads were packed into a glass column having inside diameter 1.3 cm to a length of about 7.6 cm. In another control column, 6.1 mL of bulk volume of hybrid of polystyrenehydantoin beads and hydrated ferric oxides (HFO) nanoparticles as prepared in Example 3, were packed into a glass column having inside diameter 1.3 cm to a length of about 7.6 cm. After washing the column with halogen-demand-free water until less than 0.2 mg/L of free chlorine could be detected in the effluent from the testing columns under 100 mL/min of flow rate, immediately switch to challenge solution of pH 7.0 phosphate-buffered, halogen-demand-free water containing about 10⁷ CFU (colony forming units)/mL of the Gram positive bacterium Staphylococcus aureus (ATCC 6538) was pumped through the column at a measured flow rate of about through the column at a measured flow rate of about 1.67 mL/second; 0.83 mL/second; and 0.42 mL/second respectively with a metering pump for 1 minute of pumping. The residual chlorine of the first effluent sample was quenched with 0.02N sodium thiosulfate immediately after it passed through the column. The residual chlorine from other effluent samples were quenched with 0.02N sodium thiosulfate after those samples were dwelled for 1 minute; 2 minutes; or 5 minutes later. The effluent samples were further plated. After incubation, the alive bacteria were counted. The results were summarized as the following table 1. According to table 1, with 0.83 mL/second flow rate and 2 minutes of dwell time, Dichlor PSH & HFO hybrid beads gave a 6.9 log reduction, much better than 4.98 log reduction from Dichlor PSH beads. The control column containing unhalogenated polystyrenehydantoin and the control column containing polystyrenehydantoin with HFO nanoparticles hybrid beads, both gave no reduction. The results in this example indicate that hybrid of HFO nanoparticles and poly-1,3-dichloro-5-methyl-5-(4′-vinylphenyl)hydantoin beads possess considerable efficacy against S. aureus in aqueous solution and should be excellent for disinfecting water containing same.

TABLE 1
Dichlor PSH & HFO Hybrid Efficacy against S. aureus

| | | Dichlor PSH; | Dichlor PSH & HFO |
|---|---|---|---|
| Flow rate, | Dwell | Log | hybrid; log |
| mL/s | time, min | reduction | reduction |
| 1.67 | 0, immediately | 0.09 | 0.11 |
| | quench | | |
| | 1 | 3.43 | 3.77 |
| | 2 | 4.36 | 4.47 |
| | 5 | 4.02 | 5.11 |
| 0.83 | 0, immediately | 0.45 | 0.18 |
| | quench | | |
| | 1 | 4.73 | 4.75 |
| | 2 | 4.98 | 6.91 |
| | 5 | 5.01 | 6.91 |
| 0.42 | 0, immediately | 0.29 | 0.29 |
| | quench | | |
| | 1 | 5.07 | 5.87 |

### Example 9

### Biocidal Efficacies of Dichlor PSH & HFO Hybrid Against E. coli

The beads (Dichlor PSH & HFO hybrid) as prepared in Example 7 were tested for biocidal activity against E. coli contained in water. In one test, about 3.5 g (5.9 mL of bulk volume) of Dichlor PSH & HFO hybrid beads were packed into a glass column having inside diameter 1.3 cm to a length of about 7.6 cm. In one control column, 5.9 mL of bulk volume of unchlorinated polystyrenehydantoin beads were packed into a glass column having inside diameter 1.3 cm to a length of about 7.6 cm. In another control column, 5.9 mL of bulk volume of hybrid of polystyrenehydantoin beads and hydrated ferric oxides (HFO) nanoparticles as prepared in Example 3, were packed into a glass column having inside diameter 1.3 cm to a length of about 7.6 cm. After washing the column with halogen-demand-free water until less than 0.2 mg/L of free chlorine could be detected in the effluent from the testing columns under 100 mL/min of flow rate, immediately switch to challenge solution of pH 7.0 phosphate-buffered, halogen-demand-free water containing about 10⁶ CFU (colony forming units)/mL of the Gram negative bacterium E. coli (ATCC 11229) was pumped through the column at a measured flow rate of about through the column at a measured flow rate of about 1.67 mL/second; 0.83 mL/second; and 0.42 mL/second respectively with a metering pump for 1 minute of pumping. The residual chlorine of the first effluent sample was quenched with 0.02N sodium thiosulfate immediately after it passed through the column. The residual chlorine from other effluent samples were quenched with 0.02N sodium thiosulfate after those samples were dwelled for 1 minute; 2 minutes; or 5 minutes later. The effluent samples were further plated. After incubation, the alive bacteria were counted. The results were summarized as the following table 2. According to table 2, with 1.67 mL/second flow rate and 1 minute of dwell time, Dichlor PSH & HFO hybrid beads gave a 6.57 log reduction; with 0.42 mL/second flow rate and no dwell time, Dichlor PSH & HFO hybrid beads gave a 1.87 log reduction. The control column containing unhalogenated polystyrenehydantoin and the control column containing polystyrenehydantoin with HFO nanoparticles hybrid beads, both gave no reduction. The results in this example indicate that hybrid of HFO nanoparticles and poly-1,3-dichloro-5-methyl-5-(4′-vinylphenyl)hydantoin beads possess considerable efficacy against E. coli in aqueous solution and should be excellent for disinfecting water containing same.

TABLE 2
Dichlor PSH & HFO Hybrid Efficacy against E. coli

| | | Dichlor PSH & HFO |
|---|---|---|
| Flow rate, | Dwell | hybrid; log |
| mL/s | time, min | reduction |
| 1.67 | 0, immediately | 0.11 |
| | quench | |
| | 1 | 6.57 |
| | 2 | 6.57 |
| | 5 | 6.57 |
| 0.83 | 0, immediately | 0.06 |
| | quench | |
| | 1 | 6.57 |
| | 2 | 6.57 |
| | 5 | 6.57 |
| 0.42 | 0, immediately | 1.87 |
| | quench | |
| | 1 | 6.57 |

### Example 10

### Bench Scale Testing Procedure

1. Setting Up Testing Column

9.0 ml of nanocomposite resin beads are filled into a 10 ml of disposable pipet (VWR International). The column is further connected with a pump to maintain the flow rate for selenite reduction testing. The 1 L of Ultra-Pure water is passed through the column to condition the column and then the column is ready for testing.

2. Preparing Selenite Testing Water

The selenite-containing challenge water having about 1000 ppb of selenite as Se is prepared by dissolving sodium selenite pentahydrate into Ultra-Pure water. The pH of the test water is further adjusted to 6.0 by adding 1.0N of diluted HCl acid.

3 the Evaluation of Column Testing of Selenite Removal

The selenite-containing test water in pumped thru or gravity-flow thru the column, and the flow rate is maintained around 10 ml/min during the column selenite reduction testing. The selenite-containing challenge water continues flow through the column by pump till the capacity reaches 6 liters. The 1st liter, the 2nd liter and the 6th liter of effluents from the column are collected separately for selenite determination. The all selenite-containing water samples are submitted for selenite determination according to EPA 200.8 method, “Determination of Trace Elements in Water and Waste by Inductively Coupled Plasma-Mass Spectrometry”.

4 Regeneration of the Column Nanocomposite Resin Beads

After the testing column is challenged by 6 liters of selenite-containing test water. The resin beads are supposed to reach its breakthrough point, so it is needed to be regenerated by the following procedure:

250 ml of 1.0M of NaOH solution (prepared by dissolving sodium hydroxide in deionized water) is pumped through the column at the flow rate of 7 ml/min, and keep the alkaline recycling thru the column for one hour. Then 250 ml of effluent from the column is collected separately for selenite determination. Then the column is further conditioned by pumping the pH5-6 buffer 500 ml comprising of carbonic acid and sodium bicarbonate thru the column at the flow rate 7 ml/min, keep this buffer recycling thru the column for another 1 hour at the flow rate 7 ml/min with the diluted 1N of HCl acid added dropwise to the buffer to maintain the buffer pH in the range of 5-6 during the conditioning time. Finally the column is further rinsed by 250 ml of deionized water at the flow rate of 7 ml/min. Then the column is regenerated and ready for reuse.

### Example 11

### Preparation of the Hybrid of Methylated Polystyrenehydantoin (MPSH) Beads and Hydrated Ferric Oxides (HFO) Nanoparticles

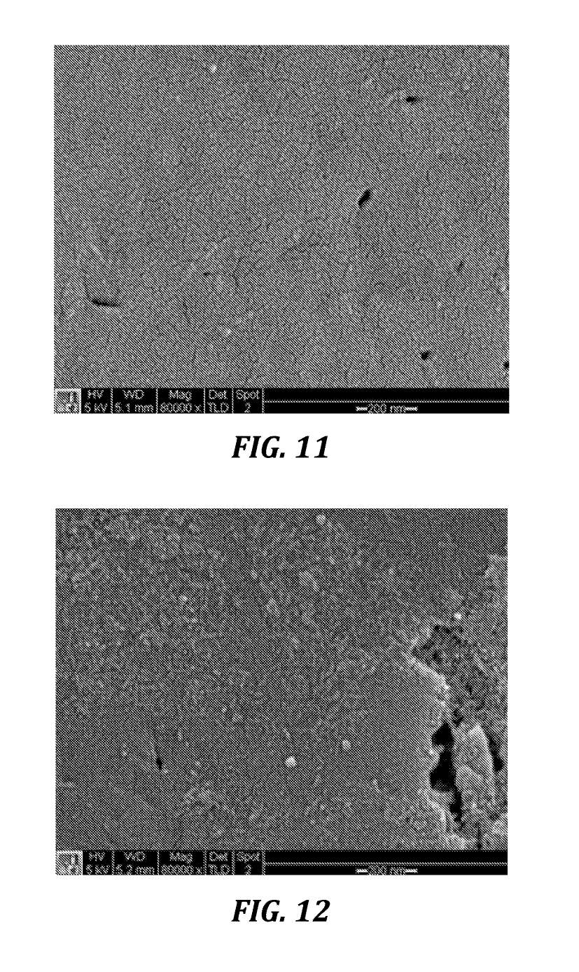

The crosslinked, porous methylated polystyrenehydantoin (MPSH) beads were prepared according to a procedure similar to that outlined in the example 1 of U.S. Pat. No. 7,687,072. The specific MPSH sample for the present invention having 9.4% of nitrogen content with batch number 197-116-2 was supplied by HaloSource Inc. a Seattle-based company. 5.0 gram of MPSH was first placed into 25 mL of 50% alcohol-water solution and stirred for 30 minutes and followed by filtration to separate the beads. Into 250 ml of beaker, 42 gram of ferric chloride hexahydrate was first dissolved in 21 mL of 50% alcohol-water solution, followed by transferring the treated MPSH into the solution. The mixture was mixed by agitation at ambient temperature for 15 hours, and followed by filtration to separate the beads. The separated beads were placed in 60 degree C. oven to dry for two hours. The dried beads were transferred into 30 mL of 1M NH₄OH solution and maintained mixing for 2 hours, and the final pH of the mixture was adjusted to 7. The beads were further separated by filtration first, and followed by transferring into 100 ml of deionized water to maintain the mixing for 15 minutes, then the beads were separated and dried in oven at 60 degree C. for two hours. The hybrid of methylated polystyrenehydantoin (MPSH) beads and hydrated ferric oxides (HFO) nanoparticles (MPSH.HFO) was obtained, and the iron content in the hybrid beads is determined by following the procedure described in Food and Agriculture Organization of UN and published in FAO JECFA Monographs 5 (2008), consisting of Fe₂O₃ extraction/digestion process and followed by Iodometric titration. The final iodometric titration of weighed and crushed beads indicated the hybrid beads contained 7.8% weight percent iron. FIG. 11 showing an SEM of methylated polystyrene (MPSH) beads compared to FIG. 12 showing an SEM of the hybrid of methylated polystyrenehydantoin (MPSH) beads and hydrated ferric oxides (HFO) nanoparticles (MPSH.HFO) indicates that the hydrated ferric oxides (HFO) nanoparticles are coated onto the methylated polystyrenehydantoin beads.

### Example 12

### Selenite Removal Testing of Hybrid of Methylated Polystyrenehydantoin (MPSH) Beads and Hydrated Ferric Oxides (HFO) Nanoparticles

The hybrid beads (MPSH.HFO) prepared from the above example 11 are further challenged by selenite water to test the selenite reduction efficacy. Approximate 2,000 ppb of selenium test water was prepared by first dissolving sodium selenite pentahydrate (Aldrich) into ultrapure water, and followed to adjust the pH to around 6.0 by addition of 1N of HCl or 1N of NaOH solution.

Into 1 L of the above-prepared test water, 1 mL of control sample MPSH (from example 11) and test sample (MPSH.HFO prepared from example 11) was respectively added and maintained stirring for two hours with the pH consistently maintained at 6.1; followed by filtration through 0.2 micron of filter, the filtrates were was collected separately and the all selenite-containing water samples are submitted for selenite determination according to EPA 200.8, “Determination of Trace Elements in Water and Waste by Inductively Coupled Plasma-Mass Spectrometry.” The results demonstrated that the hybrid of MPSH.HFO beads reduced the selenite from 1930 ppb as Se in testing water down to 957 ppb as Se. However, the control sample MPSH could only reduce the selenite from 1930 ppb as Se in testing water down to 1720 ppb as Se. The selenite reduction capacity as Se for the hybrid MPSH.HFO was calculated as 973 microgram of Se/ml of beads, and the selenite reduction capacity as Se for the control MPSH beads was calculated as 210 microgram of Se/ml of beads. The results indicated that the hybrid of MPSH.HFO beads demonstrated effective reduction of selenite from the testing water.

### Example 13

### Residual Bromine Reduction Testing of Hybrid of Methylated Polystyrenehydantoin (MPSH) Beads and Hydrated Ferric Oxides (HFO) Nanoparticles

Preparation of the Hybrid of Methylated Polystyrenehydantoin (MPSH) Beads and Hydrated Ferric Oxides (HFO) Nanoparticles

The crosslinked, porous methylated polystyrenehydantoin (MPSH) beads were prepared according to a procedure similar to that outlined in the example 1 of U.S. Pat. No. 7,687,072. The specific MPSH sample for the present invention having 9.4% of nitrogen content with batch number 197-116-2 was supplied by HaloSource Inc. a Seattle-based company. 20.0 grams of MPSH was first placed into 40 mL of 50% alcohol-water solution and stirred for 30 minutes and followed by filtration to separate the beads. Into 250 ml of beaker, 52.5 gram of ferric chloride hexahydrate was first dissolved in 26 mL of deionized water, followed by transferring the above-treated MPSH into the ferric solution. The mixture was mixed by agitation at ambient temperature for 3 hours, and followed by filtration to separate the beads. The separated beads were placed into 60 degree C. oven to dry for two hours. The dried beads were transferred into 80 mL of 4M NH₄OH solution and maintained mixing for another two hours. The beads were further separated by filtration first, and followed by washing with 50 ml of deionized water for two cycles, and the final pH of beads in the washing water was adjusted to between 7 and 8 in the second washing cycle. The final hybrid beads were separated by filtration and dried in oven at 60 degree C. for two hours. The hybrid of methylated polystyrenehydantoin (MPSH) beads and hydrated ferric oxides (HFO) nanoparticles (MPSH.HFO) was obtained, and the iron content in the hybrid beads is determined by following the procedure described in Food and Agriculture Organization of UN and published in FAO JECFA Monographs 5 (2008), consisting of Fe₂O₃ extraction/digestion process and followed by Iodometric titration. The final iodometric titration of weighed and crushed beads indicated the hybrid beads contained 11.4% weight percent iron.

2. Residual Bromine Reduction Testing of Hybrid of Methylated Polystyrenehydantoin (MPSH) Beads and Hydrated Ferric Oxides (HFO) Nanoparticles

Into two VWR 10 mL Serological pipets (VWR International, LLC) marked as column A and column B, first filled with glass fiber at the end bottom of each pipet, followed respectively placing 6 ml of Poly-1-bromo-5-methyl-5 (4′-vinylphenyl) hydantoin (CAS No. 936199-74-3) beads with lot No. TBHR 133507 having 13.6% of bromine content manufactured and supplied as Trade Name HaloPure Br or HPBr by HaloSource Inc. Column A was marked as control, and on the top of HPBr from column B (testing column) was filled with 3 ml of hybrid beads MPSH.HFO having 11.4% of iron content prepared as the above step 1 made; on the top of the column A and B, finally filled with glass fiber. Two columns were respectively connected to Peristaltic Pump supplied by Cole-Parmer Instrument. Turn on the pump, the deionized water flow directions for the testing in the column A and B were set up from bottom to upward at 8 ml/min of consistent flow rate. The deionized water was consistently pumped through column A and B, and the effluent samples from two columns were collected for each 30 minutes respectively, and the residual bromine concentration from effluent of each HPBr-containing column was measured by HACH Spectrophotometer method 8016. The results were summarized in the following table 3.

TABLE 3
Residual Bromine Reduction Testing Result

| | | Flow | Residual bromine from effluent, ppm | | | |
|---|---|---|---|---|---|---|
| | Column | rate | 30 | 60 | 90 | 120 |
| Column | material | Ml/min | min | min | min | min |
| A, control | HPBr, 6 ml | 8.0 | 0.83 | 0.83 | 0.81 | 0.85 |
| B, testing | HPBr + | 8.0 | 0.25 | 0.24 | 0.23 | 0.26 |
| | Hybrid | | | | | |
| | beads, | | | | | |
| | 6 ml + 3 ml | | | | | |

The results from the table 1 demonstrated that the column B with 3 ml of hybrid beads incorporation in the column consistently produce much lower residual bromine-containing effluent compared with the control column.

While illustrative embodiments have been illustrated and described, it will be appreciated that various changes can be made therein without departing from the spirit and scope of the invention.

1. A composition, comprising:
a polystyrene polymer comprising one or more precursor N-halamine groups or one or more N-halamine groups, wherein each group is linked to a phenyl or a benzyl group of the polystyrene polymer; and
one or more nanoparticles linked to the polystyrene polymer.

2. The composition of claim 1, wherein the precursor N-halamine group or N-halamine group is an imidazolidinone group, an oxazolidinone group, an isocyanurate group, a hydantoin group, or a 3-hydroxyalkylhydantoin group.

3. The composition of claim 1, wherein the polystyrene polymer comprises both precursor N-halamine groups and N-halamine groups, wherein precursor N-halamine groups comprise a majority.

4. The composition of claim 1, wherein the polystyrene polymer comprises both precursor N-halamine groups and N-halamine groups, wherein N-halamine groups comprise a majority.

5. The composition of claim 1, wherein the polystyrene polymer is crosslinked.

6. The composition of claim 1, wherein the polystyrene polymer comprises pores.

7. The composition of claim 1, wherein the nanoparticles are selected from iron oxides, iron oxyhydroxides, hydrated ferric oxides, titanium oxides, alumina, zirconium oxide, cerium oxide, manganese oxides, zinc oxides, magnetic iron oxides or any combination of thereof.

8. The composition of claim 1, comprising the formula 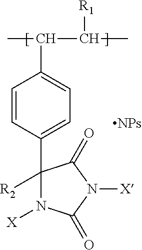
wherein:
R₁ is a hydrogen or methyl group;
R₂ is a C₁-C₈ alkyl or phenyl group;
X and X′ are independently chlorine, bromine, or hydrogen; and
NPs are nanoparticles.

9. The composition of claim 8, wherein at least one of X and X′ is chlorine or bromine.

10. The composition of claim 8, wherein X and X′ are hydrogen.

11. The composition of claim 1, comprising the formula 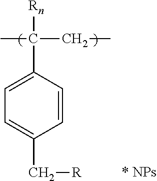
wherein R is selected from one or more of the following: 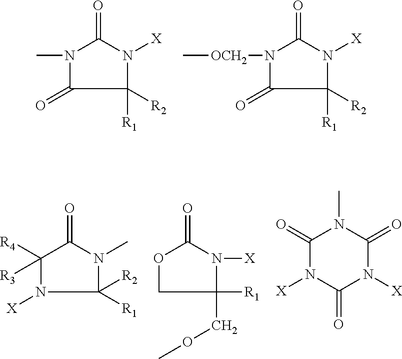
wherein:
Rₙ is a hydrogen or methyl group;
R₁ and R₂ are a C₁-C₈ alkyl or phenyl group;
X is chlorine, bromine, or hydrogen; and
NPs are nanoparticles.

12. A method of reducing contaminants from a fluid, comprising:
bringing a fluid containing contaminants into contact with a composition of claim 1 and producing decontaminated fluid.

13. The method of claim 12, wherein the contaminant comprises a halogen, chlorine, chloramine, bromine, selenium, selenite, selenate, arsenic, arsenite, arsenate, fluoride, phosphate, chromium, chromate, dichromate, a cation selected from Co²⁺, Zn²⁺, Pb²⁺, Cd²⁺, Cu²⁺, Cs⁺, Cr³⁺, Hg²⁺, Ni²⁺, or a natural organic matter (NOM), tannin, fulvic acid, humic acid.

14. The method of claim 12, further comprising inactivate microorganisms with the composition while reducing the contaminants.

15. The method of claim 14, wherein the microorganisms include viruses or bacteria or fungi.

16. The method of claim 12, further comprising bringing the fluid containing contaminants into contact with an iodinated resin or cross-linked and porous halogenated polystyrene hydantoin beads.

17. A method for regenerating a composition, comprising:
obtaining a composition of claim 1, wherein the composition has been in contact with a contaminated fluid; and
bringing the composition into contact with an alkaline aqueous liquid.

18. The method of claim 17, further comprising collecting the alkaline aqueous liquid having contaminants.

19. The method of claim 17, further comprising, after bringing the composition into contact with the alkaline aqueous liquid, rinsing the composition with a rinsing liquid, and then collecting the rinsing liquid having contaminants.

20. The method of claim 19, further comprising, after rinsing the composition with the rinsing liquid, bringing the composition into contact with a pH conditioning liquid having a pH in the range of 4 to 9.

21. A composition, comprising:
a polymer comprising one or more precursor N-halamine groups or one or more N-halamine groups; and
one or more nanoparticles linked to the polymer.

22. The composition of claim 21, wherein the polymer is crosslinked
